(19) United States
(12) Patent Application Publication
(10) Pub. No.: US 2011/0295683 A1
(43) Pub. Date: Dec. 1, 2011

(54) METHOD AND APPARATUS FOR RAPID AND SCALEABLE DIRECTED ADVERTISTING SERVICE

(75) Inventor: Wing Chit Mak, Los Angeles, CA (US)

(73) Assignee: HULU LLC, Los Angeles, CA (US)

(21) Appl. No.: 12/787,679

(22) Filed: May 26, 2010

(51) Int. Cl. G06Q 30/00

(52) U.S. Cl. 705/14.49

(57) ABSTRACT

A method and apparatus for selecting a subset of advertisements complying with an advertisement request from a set of advertisements is disclosed. Advertisements rules are specified according to a logical semantic simplifying search combinatorials yet allowing for flexible specification of advertising rules, and permitting significant precomputation of advertising rules to permit rapid identification of advertisements complying with advertisement requests. In one embodiment, advertisement rules and requests are represented as easily manipulable and computable bit arrays.

### BACKGROUND OF THE INVENTION

1. Field of the Invention

The present invention relates to systems and methods for presenting media programs, and in particular to a system and method and apparatus for rapidly selecting advertisements to be presented in conjunction with such media programs.

2. Description of the Related Art

The dissemination and playback of media programs has undergone substantial changes in the past decade. Previously, media programs (which may include audio, video, or both) were disseminated either by analog broadcast (conventional, satellite, or cable) or by physical dissemination of films to movie theaters.

These traditional dissemination and playback means remain in use after the advent of digital technology. However, digital technologies have had a profound effect on the dissemination and playback of media programs.

First, digital technology permitted the use of digital video recorders (DVRs). DVRs, while similar in function to standard analog video cassette recorders (VCRs), provide a number of additional useful functions including live pause, the ability to record one program while playing back another, and the integration of the electronic program guides with DVR functionality (so that the recordation of media programs could be scheduled far in advance and more easily).

Second, largely due to improved signal processing and more and widespread high-speed Internet access availability (e.g. DSL, fiber, and/or satellite), digital technology also permitted the dissemination and playback of media programs via the Internet. Dissemination of media programs via the Internet may occur either by simple downloading, progressive downloading or streaming.

With progressive downloading, a media file having the media program is downloaded via the Internet using dial-up, DSL, ADSL, cable, T1, or other high-speed connection, typically by a web server via the Internet.

Unlike simple downloading, in which bytes of the media file may be downloaded in any convenient order, progressive downloading downloads bytes from the beginning of a file and continues downloading the file sequentially and consecutively until the last byte. In some progressive downloading implementations, the entire file must be downloaded first before a media player can start playback. However, progressive downloading may permit media players to start playback once enough of the beginning of the file has been downloaded. Playback of progressively downloaded media files is often delayed by slow Internet connections and is also often choppy and/or contains a high likelihood of stopping after only a few seconds. Once a progressively downloaded media program has been completely downloaded, it may be stored on the end-user computer for later use.

One of the disadvantages of a progressive downloading is that the entity transmitting the data (the web server) simply pushes the data to the client as fast as possible. It may appear to be “streaming” the video because the progressive download capability of many media players allows playback as soon as an adequate amount of data has been downloaded. However, the user cannot fast-forward to the end of the file until the entire file has been delivered by the web server. Another disadvantage with progressive downloading is that the web server does not make allowances for the data rate of the video file. Hence if the network bandwidth is lower than the data rate required by the video file, the user would have to wait a period of time before playback can begin. If playback speed exceeds the data transfer speed, playback may be paused for a period of time while additional data is downloaded, interrupting the viewing experience. However, the video playback quality may be higher when the playback occurs because of the potentially higher data rate. For example, if a 100 kbps video file can be delivered over a 56 kbps modem, the video will be presented at the 100 kbps rate, but there may be periods when playback will be paused while additional video data is downloaded. The video data is typically downloaded and stored as a temporary file in its entirety.

Web servers typically use HTTP (hypertext transport protocol) on top of TCP (transfer control protocol) to transfer files over the network. TCP, which controls the transport of data packets over the network, is optimized for guaranteed delivery of data, not speed. Therefore, if a browser senses that data is missing, a resend request will be issued and the data will be resent. In networks with high delivery errors, resend requests may consume a large amount of bandwidth. Since TCP is not designed for efficient delivery of adequate data or bandwidth control (but rather guaranteed delivery of all data), it is not preferred for the delivery of video data in all applications.

Streaming delivers media content continuously to a media player and media playback occurs simultaneously. The end-user is capable of playing the media immediately upon delivery by the content provider. Traditional streaming techniques originate from a single provider delivering a stream of data to a set of end-users. High bandwidths and central processing unit (CPU) power are required to deliver a single stream to a large audience, and the required bandwidth of the provider increases as the number of end-users increases.

Unlike progressive downloading, streaming media can be delivered on-demand or live. Wherein progressive download requires downloading the entire file or downloading enough of the entire file to start playback at the beginning, streaming enables immediate playback at any point within the file. End-users may skip through the media file to start playback or change playback to any point in the media file. Hence, the end-user does not need to wait for the file to progressively download. Typically, streaming media is delivered from a few dedicated servers having high bandwidth capabilities.

A streaming media server is a specialized device that accepts requests for video files, and with information about the format, bandwidth and structure of those files, delivers just the amount of data necessary to play the video, at the rate needed to play it. Streaming media servers may also account for the transmission bandwidth and capabilities of the media player. Unlike the web server, the streaming media server communicates with the user computer using control messages and data messages to adjust to changing network conditions as the video is played. These control messages can include commands for trick play functions such as fast forward, fast reverse, pausing, or seeking to a particular part of the file. Since a streaming media server transmits video data only as needed and at the rate that is needed, precise control over the number of streams served can be maintained. Unlike the case with progressive downloading, the viewer will not be able to view high data rate videos over a lower data rate transmission medium. However, streaming media servers (1) provide users random access to the video file, (2) allows monitoring of who is viewing what video programs and how long they are watched (3) use transmission bandwidth more efficiently, since only the amount of data required to support the viewing experience is transmitted, and (4) the video file is not stored in the viewer's computer, but discarded by the media player, thus allowing more control over the content.

Streaming media servers may use HTTP and TCP to deliver video streams, but generally use RSTP (real time streaming protocol) and UDP (user datagram protocol). These protocols permit control messages and save bandwidth by reducing overhead. Unlike TCP, when data is dropped during transmission, UDP does not transmit resent requests. Instead, the server continues to send data. Streaming media servers can also deliver live webcasts and can multicast, which allows more than one client to tune into a single stream, thus saving bandwidth.

Typically, progressively downloaded media is transmitted to the user computer at a rate that is faster than playback. The media program player buffers this data, and may indicate how much of the media program has been buffered by providing an indicator, usually as a part of a “progress bar.” A control is often provided that allows the user to go to any point in the program that has already been buffered by selecting the control and moving it to a different location along the progress bar. This allows the user to randomly access any buffered portion of the media program.

Streaming media players do not rely on buffering to provide random access to any point in the media program. Instead, this is accomplished through the use of control messages transmitted from the media player to the streaming media server.

The delivery of media programs can be accomplished under a variety of models. In one model, the user pays for the viewing of the media program (for example, using a pay-per-view service). In another model widely adopted by broadcast television shortly after it's inception, sponsors pay for the presentation of the media program in exchange for the right to present advertisements during or adjacent to the presentation of the program.

The advent of DVRs has had a profound effect upon the advertising model described above. DVRs permit the user to record media programs (in advance or during their broadcast), and permit the user to easily bypass advertisements presented during the media program by use of trick-play functions such as fast forward and reverse.

However, DVRs are not capable of these operations with media programs provided as streaming media. In such cases, the user must view the advertisements. The fact that users cannot skip advertisements within streamed media using a DVR-like device is both a strength and a weakness of this media program delivery paradigm. It is a strength, because advertisers can be assured that the viewers are actually watching the advertisements placed within the media program and not skipping them. However, it also represents a barrier to the widespread viewing of media programs via streaming media because users prefer to skip advertisements that are not of interest.

It is known that advertisements can be generally directed to users based on information gleaned from the user's clickstream through a website or from demographic information provided by the user. Such “directed advertisements” are typically much more effective, since they are directed at items that are more likely to be of interest to the user.

However, providing directed advertisements in a streaming media context is a challenging proposition, because it involves finding an optimal (or at least near optimal) match between a large and rapidly varying number of users with a large and rapidly varying number of advertisements, based upon a large number of rules, and doing so in a potentially very short period of time.

What is needed is an method and apparatus for rapidly selecting an appropriate advertisement to display to a user based on a match between user information and targeting rules that define which advertisements should be shown to which users. What is also needed is a method and apparatus for making such selections that is easily and rapidly scaleable so that it may handle large and rapidly varying numbers of users and advertisements. The present invention satisfies that need.

### SUMMARY OF THE INVENTION

To address the requirements described above, the present invention discloses a method and apparatus for selecting a subset of advertisements complying with an advertisement request from a set of advertisements. In one embodiment, the method comprises the steps of accepting an advertisement rule for each advertisement of the set of advertisements, wherein each advertisement rule describes circumstances in which the associated advertisement belong to the subset of advertisements, and each advertisement rule comprises one or more advertisement rule primitives including a advertisement rule key and a advertisement rule value associated with the advertisement rule key; precomputing a first map relating each advertisement its advertisement rule; accepting an advertisement request having one or more advertisement request keys, each of the advertisement request keys having one or more advertisement request values; retrieving, in response to the advertisement request, at least a portion of the precomputed map, the at least a portion describing the advertisement rules for which advertisement rule values match the advertisement request values; computing a second map from the portion of the precomputed map; and selecting the subset of advertisements from the second map as only those advertisements having advertisement rules satisfied by all of the advertisement request values.

In another embodiment, the present invention is evidenced by an advertisement server for selecting a subset of advertisements complying with an advertisement request from a set of advertisements. The advertisement server comprises a metadata cache service, the metadata cache service that accepts an advertisement rule for each advertisement of the set of advertisements and precomputes a first map relating each advertisement its advertisement rule. Each advertisement rule describes circumstances in which the associated advertisement belong to the subset of advertisements and each advertisement rule comprises one or more advertisement rule primitives having a advertisement rule key and a advertisement rule value associated with the advertisement rule key. The advertisement server further comprises an advertisement selection service communicatively coupled to the metadata cache service, for accepting an advertisement request having one or more advertisement request keys, each of the advertisement request keys having one or more advertisement request values, for retrieving, in response to the advertisement request, at least a portion of the precomputed map, the at least a portion describing the advertisement rules for which advertisement rule values match the advertisement request values, for computing a second map from the portion of the precomputed map, and for selecting the subset of advertisements from the second map as only those advertisements having advertisement rules satisfied by all of the advertisement request values.

### BRIEF DESCRIPTION OF THE DRAWINGS

Referring now to the drawings in which like reference numbers represent corresponding parts throughout:

FIG. 1 is a diagram illustrating an exemplary media program system;

FIG. 2 illustrates an exemplary computer system that could be used to implement aspects of the present invention;

FIG. 3 is a diagram illustrating operations that can be used to deliver media programs and advertisements for presentation to a user;

FIG. 4 is a diagram of one embodiment of a process for selecting a subset of advertisements from a set of advertisements based on matching advertisement requirements with advertisement request parameters;

FIG. 5 is a diagram pictorially depicting one embodiment of an advertisement rule having advertisement rule primitives defining keys and values;

FIG. 6 is a diagram pictorially depicting one embodiment of an advertising request having advertising request keys and advertising request values;

FIG. 7 is a diagram illustrating exemplary method steps that can be used to precompute a first map;

FIG. 8 is a diagram illustrating exemplary method steps that can be used to compute the include set;

FIGS. 9-16 are diagrams illustrating the computation of the include set;

FIG. 17 is a diagram illustrating exemplary method steps that can be used to compute the exclude set;

FIGS. 18-23 are diagrams illustrating the computation of the exclude set;

FIG. 24 is a diagram illustrating exemplary method steps that can be used to compute the empty set;

FIGS. 25-28 are diagrams illustrating the computation of the empty set;

FIG. 29 is a diagram of an exemplary first map;

FIG. 30 is a diagram of the exemplary first map highlighting portions that match the advertising request;

FIG. 31 is a diagram showing method steps that can be used to compute the second map; and

FIG. 32 is a diagram illustrating exemplary method steps that can be used to select the subset of advertisements from the second map.

### DETAILED DESCRIPTION OF PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

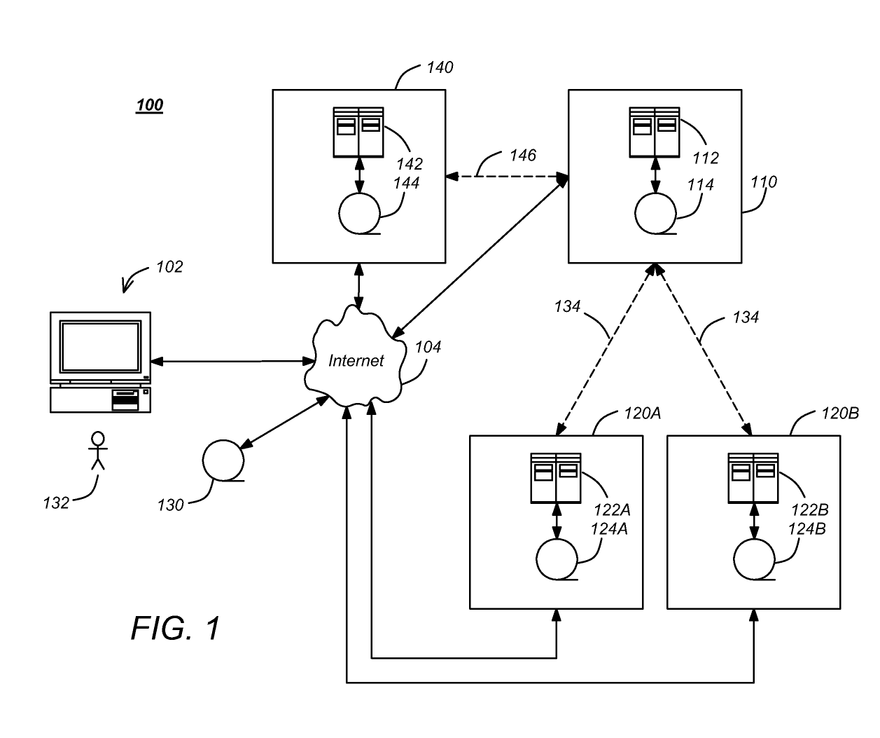

FIG. 1 is a diagram illustrating an exemplary media program system 100. In the illustrated embodiment, the system 100 may comprise one or more media program sources 120A, 120B, communicatively coupled to a communication network 104 such as the Internet and each having one or more source video servers 122A, 122B communicatively coupled to one or more source media program databases 124A, 124B. The media program system 100 further comprises a media program provider 110, communicatively coupled to the communication network 104, and having one or more provider video servers 112 and one or more provider databases 114. In one embodiment, the media program provider 110 is a video-on-demand and/or streaming media program provider.

The media program system 100 may stream media programs to the user's computer 102 directly from the media program provider 110, or the media program provider 110 may operate as a portal, providing an interface to the media programs available from the media program sources 120A and 120B, but not the media program itself (which is instead provided by the media program source(s) 120).

In the first case, the media program provider 110 licenses media programs from the media program sources 120 (such as www.fox.com or www.nbc.com), and metadata for such programs is also typically provided to the media program provider 110 from the media program source 120 as well. Such metadata can be retrieved by the media program provider's database 114 for use. If supplementary metadata is required, it can be obtained from a metadata source 130 independent from the media program provider 110 and the media program source 120, as described further below.

In the second case, the media programs are streamed to the user's computer 102 directly from the servers of the media program source 120. When the media program is streamed directly from the media program source 120, it is often the case that the metadata provided by the media program source 120 is insufficient. In such cases, supplementary metadata may be obtained from independent metadata source 130 (such as www.tv.com or www.imdb.com) or other third party sources. In this circumstance, the role of the media program provider 110 is that of a portal that provides the user 132 a list of available media programs and an interface to search to find such programs and to view them.

Media programs and metadata may be obtained via a communication network 104 such as the Internet, or through auxiliary (and/or dedicated) communication links 134). Such information may be obtained by webcrawling (for example, using a program or automated script that browses the World Wide Web in a methodical, automated manner).

Using the computer 102, remote users 132 can communicate with the media program provider 110 using the communication network 104, to obtain media programs (including video-on-demand and/or streaming video services) and to search the provider media program database 114 to find media programs of interest.

The media program system 100 may also comprise one or more advertisement providers 140, which supply advertisements that are replayed in connection with the media programs provided by the media program provider 110 or media program sources 120. In the illustrated embodiment, the advertisement provider 140 includes an advertisement provider server 142 communicatively coupled to an associated and communicatively coupled advertisement provider database 144.

Advertisements may be supplied from the advertisement provider 140 to the media program provider 110 via the Internet 104, a dedicated link 146, or by physical exchange of a memory storage device having the advertisement. Such advertisements can be provided to and stored by the media program provider 110 and streamed or downloaded along with the media program to the user computer 102 at the appropriate time.

In one embodiment, the advertisements are integrated with the streamed or downloaded video from the media program provider 110. In another embodiment, the advertisements are not integrated with the media program, but are instead transmitted to the user computer 102 separately from the media program, and replayed at the appropriate time using indices that indicate when each advertisement should be presented. For example, advertisements can be indexed and streamed or downloaded to the user computer 102 (from the media program provider 110 or the advertisement provider 140), and such advertisements can be played back to the user 132 at times indicated by corresponding indices in the media program.

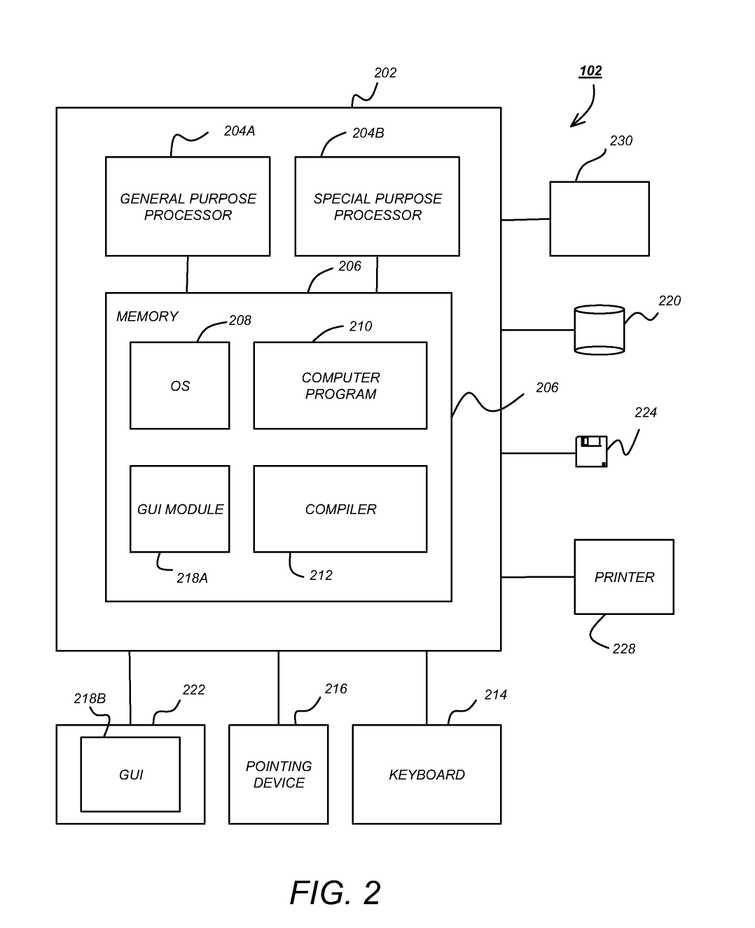

FIG. 2 illustrates an exemplary computer system 202 that could be used to implement elements of the present invention, including the user computer 102, servers 112, 122, and 142 and the databases 114, 124, and 144. The computer 202 comprises a general purpose hardware processor 204A and/or a special purpose hardware processor 204B (hereinafter alternatively collectively referred to as processor 204) and a memory 206, such as random access memory (RAM). The computer 202 may be coupled to other devices, including input/output (I/O) devices such as a keyboard 214, a mouse device 216 and a printer 228.

In one embodiment, the computer 202 operates by the general purpose processor 204A performing instructions defined by the computer program 210 under control of an operating system 208. The computer program 210 and/or the operating system 208 may be stored in the memory 206 and may interface with the user 132 and/or other devices to accept input and commands and, based on such input and commands and the instructions defined by the computer program 210 and operating system 208 to provide output and results.

Output/results may be presented on display 222 or provided to another device for presentation or further processing or action. Typically, the display 222 comprises a plurality of picture elements (pixels) that change state to collectively present an image to the user 132. For example, the display 222 may comprise a liquid crystal display (LCD) having a plurality of separately addressable pixels, each with a liquid crystal that changes to an opaque or translucent state to form a part of the image on the display in response to the data or information generated by the processor 204 from the application of the instructions of the computer program 210 and/or operating system 208 to the input and commands. Similarly, plasma displays include a pixel having three separate subpixel cells, each with a different color phosphor. The colors blend together to create the color presented in the pixel. Pulses of current flowing through the cells are varied according to the data generated by the processor from the application of the instructions of the computer program and/or operating system 208 in response to input and commands, changing the intensity of the light provided by the pixel. Also, similarly, cathode ray tube (CRT) displays include a plurality of pixels, each with each pixel having subpixels typically represented by dots or lines from an aperture grille. Each dot or line includes a phosphor coating that glows when struck by electrons from an electron gun. In response to the data generated by the processor from the application of instructions of the computer program and/or operating system 208 and in response to input and commands, the electrons emitted by the electron gun are steered at the dots or lines, thus changing the state of the associated pixel by causing the phosphor coating of that dot or line to glow.

The image may be provided through a graphical user interface (GUI) module 218A. Although the GUI module 218A is depicted as a separate module, the instructions performing the GUI functions can be resident or distributed in the operating system 208, the computer program 210, or implemented with special purpose memory and processors.

Some or all of the operations performed by the computer 202 according to the computer program 110 instructions may be implemented in a special purpose processor 204B. In this embodiment, some or all of the computer program 210 instructions may be implemented via firmware instructions stored in a read only memory (ROM), a programmable read only memory (PROM) or flash memory in within the special purpose processor 204B or in memory 206. The special purpose processor 204B may also be hardwired through circuit design to perform some or all of the operations to implement the present invention. Further, the special purpose processor 204B may be a hybrid processor, which includes dedicated circuitry for performing a subset of functions, and other circuits for performing more general functions such as responding to computer program instructions. In one embodiment, the special purpose processor is an application specific integrated circuit (ASIC).

The computer 202 may also implement a compiler 212 which allows an application program 210 written in a programming language such as COBOL, C++, FORTRAN, or other language to be translated into processor 204 readable code. After completion, the application or computer program 210 accesses and manipulates data accepted from I/O devices and stored in the memory 206 of the computer 202 using the relationships and logic that was generated using the compiler 212.

The computer 202 also optionally comprises an external communication device such as a modem, satellite link, Ethernet card, or other device for accepting input from and providing output to other computers.

In one embodiment, instructions implementing the operating system 208, the computer program 210, and the compiler 212 are tangibly embodied in a computer-readable medium, e.g., data storage device 220, which could include one or more fixed or removable data storage devices, such as a zip drive, floppy disc drive 224, hard drive, CD-ROM drive, tape drive, DVD, etc. Further, the operating system 208 and the computer program 210 are comprised of computer program instructions which, when accessed, read and executed by the computer 202, causes the computer 202 to perform the steps necessary to implement and/or use the present invention or to load the program of instructions into a memory, thus creating a special purpose data structure causing the computer to operate as a specially programmed computer executing the method steps described herein. Computer program 210 and/or operating instructions may also be tangibly embodied in memory 206 and/or data communications devices 230, thereby making a computer program product or article of manufacture according to the invention. As such, the terms “article of manufacture,” “program storage device” and “computer program product” as used herein are intended to encompass a computer program accessible from any computer readable device or media.

Of course, those skilled in the art will recognize that any combination of the above components, or any number of different components, peripherals, and other devices, may be used with the computer 202.

Although the term “user computer” is referred to herein, it is understood that a user computer 102 may include portable devices such as cellphones, portable MP3 players, video game consoles, notebook computers, pocket computers, personal data assistants (PDAs) or any other device with suitable processing, communication, and input/output capability.

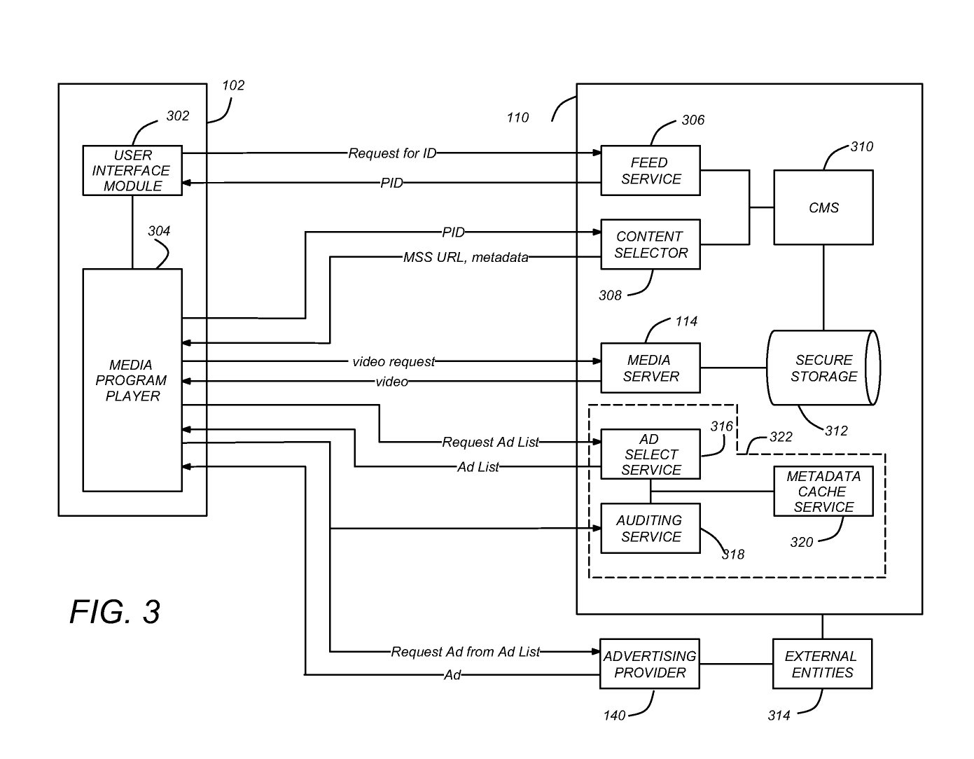

FIG. 3 is a diagram illustrating a content delivery subsystem (CDS) 300 and top-level operations that can be used to deliver media programs and advertisements for presentation to a user 132. In this embodiment, the content delivery subsystem 300 includes the user computer 102, the media program provider 110, and an advertisement provider 140. Although the advertisement provider 140 is illustrated as a separate architectural entity than the media program provider 110, the advertisement provider 140 may be integrated within the media program provider 110. The CDS 300 provides a means to provide media programs and advertisements across a plurality of distribution networks, which may include www.hulu.com, www.imdb.com, www.aol.com or www.msn.com. Metadata related to media program and advertisement content is stored in the content delivery system 300, as is data describing where the media programs and advertisements may be found within the CDS 300.

The user computer 102 includes an interface module 302 and a media program player 304. The interface module 302 includes instructions performed by the user computer 102 that are used to present information to the user 132 and to accept user input, including commands. The presented information may include a program guide, advertisement options (as discussed further below), and the user input may include selected advertisement options and media program playback selections.

Using the user computer 102 and the interface module 302, the user 132 enters a choice for a media program. The user interface module 302 transmits a request message to a feed service 306 implemented by the media program provider 110 for a program identifier (PID). The PID is used to identify content such as a specific media program running on a specific distribution network. For example, season 2 of “The Office” running on www.hulu.com will have a different PID than the same exact show running on www.msn.com.

The feed service 306 then returns the PID to the user interface module 302. The PID and associated commands (e.g. the play command) are provided to the media program player 304. The media program player 304 may be embedded in a webpage from a third party, or may be part of a webpage maintained by the media program provider 110, or may be implemented in a standalone application.

The media program player 304 transmits the PID to a content selector 308 implemented by the media program provider 110. The content selector 308 identifies the actual path (uniform resource locator or URL, for example) to the requested media program associated with the transmitted PID, as well as programming metadata that is used by the media program player 304 to help identify restrictions (for example, preventing access to adult-themed content if the user 132 is known to be under 18), advertising targeting rules as well as advertising breaks. The advertising breaks indicate where advertisements may be inserted, and can be specified in terms of the time since the beginning of the media program, the time remaining, or any other suitable measure. The URL and the metadata are then transmitted to the media program player 304. The media program player provides a video request to the media server 114 at the URL received from the content selector 308. The video request includes the PID and may include other information as well. The video request may be for streaming or progressively downloading the requested media program.

The media streaming server (MSS) 114 responds to the video request by providing the media program to the user computer 102. In one embodiment, the MSS 114 is a service provider that has a wide range of geographically distributed computers that store replicated copies of media programs and website content. The MSS 114 can be a third party provider (e.g. only contractually associated with the media program provider 110), or can be part of the media program provider 110. Geographically diverse servers assures that when the user 132 requests playback of a media program, the media program is streamed from a geographically local server, to increase media program playback performance. Multiple servers also offer redundancy.

The MSS 114 obtains the media program from secure storage 312 which may be disposed in the media program provider 110 facility, or which may be disposed at a third party facility. The content management service 310 interfaces with the feed service 306, the content selector 308, and secure storage 312 to manage which media programs are provided to the media server 114. External entities 314 can include third parties such entities that provide the advertisements that are to be displayed to the user (which includes sponsors and/or their advertising agencies), third party providers of media programs, and entities from which the user 132 may purchase goods or services as further described below.

The media program is transmitted to the media program player 304. The media program may be streamed or progressively downloaded to the media program player 304. At or before the times identified in the advertising breaks defined above, the media program player 304 transmits an advertisement list request to the advertisement server (ad server) 322.

### Ad Server

The ad server 322 includes an ad selection service 316, an auditing service 318 and a metadata cache service 320.

The ad selection service 316 is responsible for processing ad selection requests from the media program player 304 and decides on what advertisements the video player should display to the end user during an ad-break while honoring ad-targeting rules and campaign delivery (or pacing) constraints. Here, an ad-break is more generally defined as any temporal opportunity to show advertisements either before the media program is played (pre-roll), after the media program is played post-roll, or time slots during (interstitial) the video content that the user is watching (which may be predefined).

The ad selection service 316 is also responsible for tracking the number of times individual ads are selected and/or qualify for an ad selection request which will then be forwarded to the metadata cache service 320 for pacing calculations. These selection/qualification counters are maintained on a cumulative basis, and each instance of the ad selection service 316 may use an embedded database to persist them so progress can be preserved across service restarts and upgrades. Periodically, counters in the local database will also be synchronized to a global MySQL counters database (and vice versa in recovery scenario) to provide a single point of access for counters from all of the ad selection service 316 instances as well as an extra level of redundancy. In one embodiment, the ad selection service 316 is implemented in Java as a servlet running inside Apache Tomcat. Multiple instances of the ad selection service 316 can run simultaneously over geographically

The auditing service 318 is responsible for tracking the number of ad impression calls from the media player 304 on a per-ad basis and forward the impression counts to the metadata cache service 320 for pacing calculations. Note that the impression counters maintained by the auditing service 318 are only meant for providing near-real time feedback to the metadata cache service 320 for more accurate pacing calculations rather than for official billing/financial purposes. Instead, the number of impressions that advertisers eventually get billed comes from analyzing the service logs of the auditing service 318. Because of the critical nature of the impression log used for billing or financial purposes, a robust distributed edge server network is used as proxy to the auditing service 318 for the actual logging of impression calls.

Similar to the ad selection service 316, the auditing service 318 may implemented in Java as a servlet running inside Apache Tomcat. Each instance of the auditing service 318 also maintains a local Apache Derby impression counter database that gets periodically synchronized to the global MySQL counters database. Furthermore, the auditing service 318 is capable of having multiple instances of itself running over potentially geographically dispersed locations just like the ad selection service 316.

The metadata cache service 320 provides the following support services to the ad selection service 316 and the auditing service 318:
1. The metadata cache service 320 periodically updates the ad selection service 316 with the latest targeting rules as well as ad campaign and video metadata in a preprocessed form that facilitates the ad selection process.
2. The metadata cache service 320 periodically updates the ad selection service 316 with the latest pacing information including the set of rate controlled/limited ads and the relative selection weights of all live ads.
3. The metadata cache service 320 accepts updates of selection and impression counters of live ads from (potentially multiple instances of) the ad selection service 316 and the auditing service 318 respectively. The metadata cache service 320 stores these counter updates in memory for easy access during pacing calculation.
4. The metadata cache service 320 periodically updates the auditing service 318 with the latest set of valid creative and placement IDs.
5. The metadata cache service 320 periodically updates 7-day-hourly inventory models for all live ads using qualification counters collected in the global counters database. The metadata cache service 320 uses these inventory models to determine how best to deliver a campaign over the next 7 days when performing pacing calculations.

Only one instance of the metadata cache service 320 needs to be running to support all live instances of the ad selection service 316 and the auditing service 318 in production so all the ad selection services 316 get essentially the same near-real-time pacing information from a single the metadata cache service 320. Secondary instances of the metadata cache service 320 can run alongside the live instance to support side-by-side upgrade and fail-over scenarios but their pacing information will be based on slightly outdated selection and impression counters collected in the central counters.

The ad selector service 316 returns a message having an advertisement or playback list that describes which advertisements the player needs to play to the user at the appropriate advertisement breaks. The advertisement list may include the following information: (1) URLs of the advertisements/files (advertisements may include videos, banners and canvas). Advertisements may be hosted at the advertising provider 140, external entities 314 or the media program provider 110 and (2) the address or URL for impression audit calls to an auditing service 318. The auditing service 318 keeps track of which advertisements are presented to the user and when, and may be implemented by the media program provider 110 or by a third party service.

When the media program player 304 reaches and advertisement break, an ad is requested from the advertisement list using the URL, and an audit call is made to the auditing service 318. The advertisement is then received from the advertising provider and provided to the media program player 304 for display to the user. Typically, the advertising requested advertisement is streamed to the media program player 304 at the appropriate time, where it is displayed to the user 132, however, the media server 114 may obtain the advertisements from the advertising provider 140 and inserts the advertisements in the media program before or while the media program is streamed or progressively downloaded to the media program player 304.

### Advertisement Playlist Selection

Advertisement providers 140 typically have very specific requirements or rules that describe the circumstances in which they would like their advertisement to be presented to a user. For example, many advertisers do not want their advertisements to be presented in conjunction with media programs having R-rated content. Other examples including directing advertisements for gender-specific products only at the applicable gender or regional services only to users in that particular region. As a consequence, it is important that the advertisement server 322 quickly and accurately match advertisements with advertisement requests that meet the advertisement requirements. Since this must be accomplished in near real time, the process must be both rapid and reliable, and since the number of possible advertisements could be very large, the process must be scaleable.

At a more abstract level, an ad request from the video player can be considered to be a description of an ad serving opportunity, and choosing a proper semantic representation to describing the advertisement selection request can be a delicate balance between providing a flexible ad targeting rule semantic, providing for runtime efficiency of the ad matching algorithm, and ease of use for those working with the advertisement serving system throughout the day. Many advertisement servers (video or otherwise) accepts key-value (or attribute type-value) pairs to target advertisements at particular demographics. However, if all advertisement requests are expressed only as one or more of such key-value pairs, the advertisement selection can be simplified and accelerated.

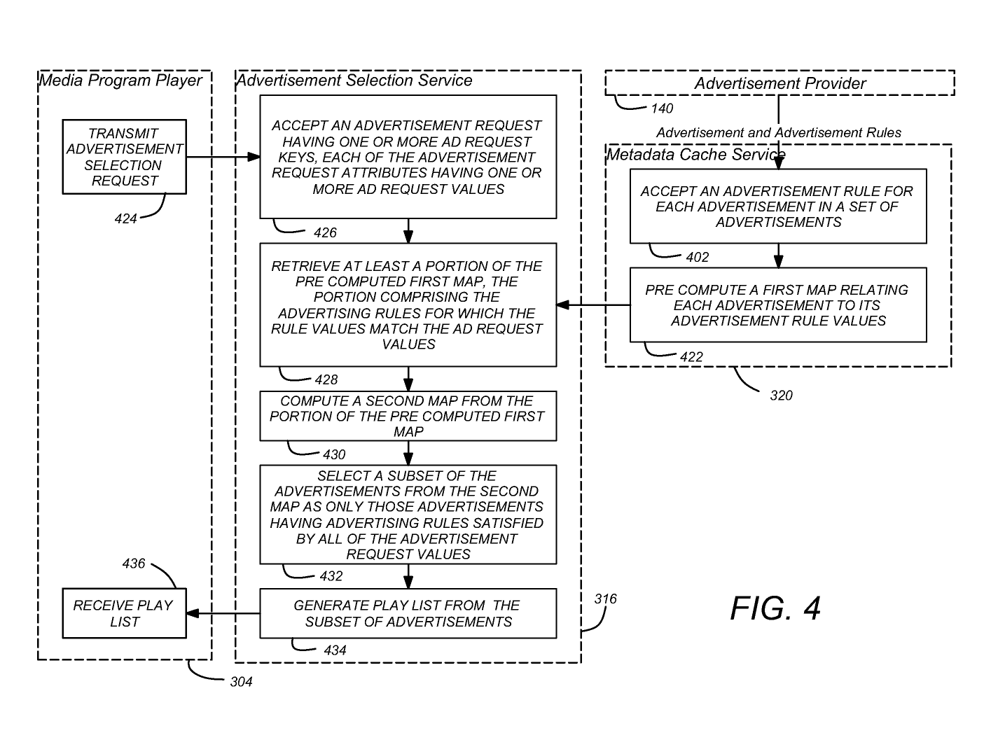

FIG. 4 is a diagram of one embodiment of a process for selecting a subset of advertisements from a set of advertisements based on matching advertisement requirements with advertisement request parameters. First a plurality of advertisements are accepted from one or more advertisement providers 140, as shown in block 402. Each such advertisement is associated with an advertisement rule that defines the circumstances in which the associated advertisement qualifies to be provided in response to an advertising request from the media program player 304. Together, such advertisements constitute a set of advertisements from which the advertisement server 322 will select a subset of advertisements that may be replayed by the media program player at the appropriate time.

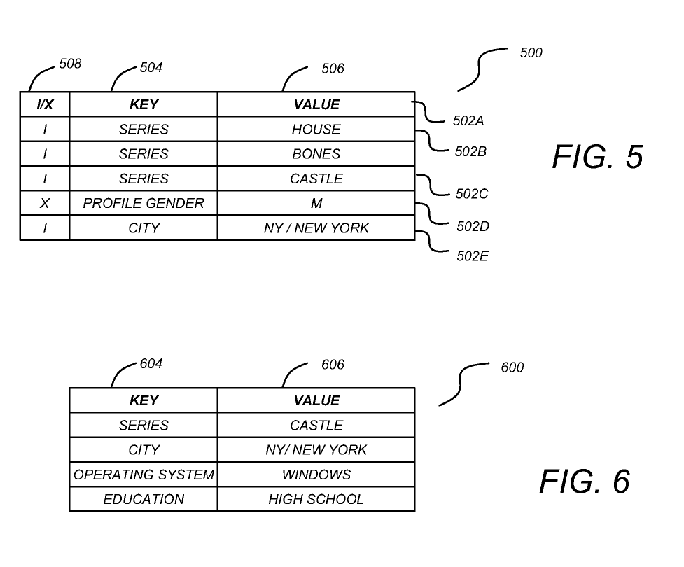

FIG. 5 is a diagram pictorially depicting one embodiment of an advertisement rule 500 having advertisement rule primitives 502A-502E (collectively referred to hereinafter as 502) that define keys 504 and values 506 or key-value pairs that are to be included in an advertising request for the advertisement to satisfy the advertisement request, and key-value pairs that are to be excluded from the advertising request to satisfy the advertising request. In this example, the advertisement rule requires that the advertisement be shown in connection with the series “HOUSE,” “BONES,” or “CASTLE,” to a user in New York City, and not to a male. As shown in FIG. 5, advertisement rule primitives 502 can be defined to have “include” primitives (indicated by the include designator “I”) and “exclude” primitives (indicated by the exclude designator X):
1 Include Advertisement Request Primitive: Include (I) a specific key (K)-value (V) pair (henceforth denoted as I:<K>,<V>) indicates that an advertising request must include they specified value <V> for the key <K>. For example, the advertisement rule primitive “I:CONTENT PARTNER,FBC” primitive will evaluate to a logical TRUE if and only if (iff) an advertisement request contains a key-value pair of “CONTENT PARTNER=FBC”. Thus, the I:CONTENT PARTNER,FBC advertising rule primitive evaluates as TRUE for the sample given above, since the advertisement request includes a key-value pair describing that the CONTENT PARTNER key includes value FBC.
2 Exclude Advertisement Request Primitive: Exclude (X) a specific key-value pair (henceforth denoted as X:<K>,<V>) indicates that an advertising request must not include the specified value <V> for the key <K>. For example, the X:CONTENT RATING,R primitive will evaluate to FALSE iff an ad request contains the “Content Rating=R” key-value pair. Thus, the X:CONTENT RATING,R advertising rule primitive will evaluate as TRUE for the sample given above, since the content rating is TV-14.

To specify a more elaborate advertisement rule, multiple advertisement primitives 502 can be combined together with logical AND (&) and OR (|) operators, and an advertisement request would be said to satisfy the combined targeting rule if and only if the expression evaluates to TRUE. For example, the targeting rule:

X:CITY,CA/LOS ANGELES&I:SERIES,HOUSE&I:GENDER,F

will only match ad requests from female users outside of Los Angeles watching House.

The ad server 322 may be configured to allow arbitrary combination of the targeting primitives via AND and OR operations in the advertisement rule specification. However, such open-ended flexibility requires substantial complex computations so that all of the combinatorial possibilities are explored before arriving at a set of possible advertisements having rules that match advertising requests. This can limit the number of key-value pairs that can be considered and/or the number of candidate advertisements that can be considered, can place substantial demands on the computational speed and/or capacity of the computers performing such computations, and reduce response time. Of these factors, the reduced response time is perhaps the most onerous, as when an advertising request is received, the advertising server 322 often must generate a list of advertisements having primitives that satisfy the parameters of the advertising request.

Instead, the ad server 322 described herein adopts a more restrictive scheme for defining and combining advertisement rule primitives. This more restrictive scheme still permits virtually any logical combination of advertising rules 500, yet mandates that they be defined according to a semantic that allows most computations to be performed before the advertisement request is received. The semantic also allows the computations to be performed much more rapidly and using less memory than would be the case in a conventional system. Key features of the advertising rule semantic are:
(1) Advertisement rule primitives 501 are grouped by advertisement rule key 504 for evaluation;
(2) An advertisement request satisfies key group K₁ (for example, the key group “SERIES” in FIG. 5) iff:
   (a) It includes at least one of values specified by the set of “include” advertising rules for key group K₁ (in other words, the “SERIES” key group includes either the value “HOUSE,” “BONES,” OR “CASTLE,” and
   (b) It does not contain any of the values specified by the exclude rules for key group K₁ (in other words, the “PROFILE GENDER” key group does not include “M”);
(3) An advertisement request satisfies the advertisement rule defined for an advertisement iff it satisfies all advertisement rule key-groups (in other words, the advertisement request must include at least one of HOUSE, BONES, AND CASTLE values from the SERIES key group, include a NY/NEW YORK value for the CITY key group, and exclude M for the PROFILE GENDER key group.

More formally, the semantics of the advertisement rules in the ad server 322 are restricted to Boolean expressions of the form:

((X:K₁,V₁& . . . &X:K₁,Vₖ)%(I:K₁,Vₖ₊₁| . . . |I:K₁,Vₖ₊₁))& . . . &((X:Kₙ,V₁& . . . &X:Kₙ,Vₚ)&(I:Kₙ,Vₚ₊₁| . . . |I:Kₙ,Vₖ₊₁))

Under the foregoing restricted semantics, multiple advertisement rule primitives 502 for the same key-value can always be simplified into a single advertisement rule primitive 502 because:
1 Multiple “include” primitives 502A-502C, 502D for the same key-value can always be simplified into a single “include” primitive without changing the result of (2)-(a) above;
2 Multiple “exclude” advertisement rule primitives 502D for the same key-value can also be simplified into a single exclude primitive without changing the result of (2)-(b) above; and
3 An exclude advertising rule primitive 502D for a key-value pair effectively has precedence over an include primitive for the same key-value pair.

In other words, there can be at most one effective advertising rule primitive for each distinct key-value pair. In fact, under the above semantic, we can omit the & and | operators altogether since there is only one way to connect a given set of targeting primitives, as shown in Table I below:

TABLE I

| I/X | Key | Value |
|---|---|---|
| X | K₁_{ₓ} | V₁_{ₓ}_{,1} |
| . . . | . . . | . . . |
| X | K₁_{ₓ} | V₁_{ₓ}_{,n}_{₁} |
| I | K₁_{_{I}} | V₁_{_{I}}_{,1} |
| . . . | . . . | . . . |
| I | K₁_{_{I}} | V₁_{_{I}}_{,m}_{₁} |
| . . . | . . . | . . . |
| X | Kₚ_{ₓ} | Vₚ_{ₓ}_{,1} |
| . . . | . . . | . . . |
| X | Kₚ_{ₓ} | Vₚ_{ₓ}_{,n}_{ₚ} |
| . . . | . . . | . . . |
| I | Kₚ_{_{I}} | Vₚ_{_{I}}_{,1} |
| . . . | . . . | . . . |
| I | Kₚ_{_{I}} | Vₚ_{_{I}}_{,m}_{ₚ} |

Wherein X refers to a key-value pair that define an exclusion from the rule, and I refers to a key-value pair that define an inclusion to the rule, V₁_{ₓ}_{,1} . . . V₁_{ₓ}_{,n}_{₁} refer to the n₁ distinct values for the first exclude key K₁_{ₓ} and V₁_{_{I}}_{,1} . . . V₁_{_{I}}_{,m}_{₁} refer to the m₁ distinct values for the first exclude key K₁_{_{I}}. Note that there may be K_{P}_{ₓ} exclude keys and K_{P}_{_{I}} include keys, and that for any particular key, key values are distinct across exclude (X) and include (I) targeting primitives.

FIG. 6 is a diagram showing an advertising request 600 having advertising request keys 504 and advertising request values 506. This advertisement indicates that the series being viewed by the user is “CASTLE,” that the user is located in New York City, uses a WINDOWS operating system and has a high school education.

Applying the advertising rule of FIG. 5 to an advertising request of FIG. 6 and evaluating the advertising rule primitives individually produces the truth table shown in Table II:

TABLE II

| I/X | Key | Value | Evaluation |
|---|---|---|---|
| I | Series | House | FALSE |
| I | Series | Bones | FALSE |
| I | Series | Castle | TRUE |
| X | Profile Gender | M | TRUE |
| I | City | NY/New York | TRUE |

Notice that the “X:PROFILE GENDER,M” advertising rule primitive evaluates to TRUE because the given request doesn't contain an advertising key-value pair “PROFILE GENDER,M”. In fact, the given request doesn't have an advertising request values for the advertising request key “GENDER” at all.

Also note that the advertisement request includes advertisement request key-values that are not required by the advertising rule (e.g. “OPERATING SYSTEM,WINDOWS” and “EDUCATION,HIGH SCHOOL”). These advertising rules therefore have no bearing on the final outcome of whether the advertisement request matches any of the advertisements, as defined by the advertisement rule.

Rolling up the result of the targeting primitives to their corresponding key group will give the result shown in Table V. Note that the Series key-group evaluates to true because at least one of the include advertisement rule primitives evaluates to true (series=CASTLE):

TABLE III

| | |
|---|---|
| Series | TRUE |
| Profile Gender | TRUE |
| City | TRUE |

Further, since all key-groups specified in the advertisement rule evaluate to TRUE when compared to the advertising request, the given advertising request is considered a match for the advertising rule.

Consider the ad request shown in Table IV:

TABLE IV

| Key | Value |
|---|---|
| Series | Naruto |
| Site Channel | Animations and Cartoons |
| Site Channel | Animations and Cartoons/Anime |
| City | CA/Los Angeles |
| Player Mode | site |

and the advertising rule shown in Table V:

TABLE V

| I/X | Key | Value |
|---|---|---|
| I | Site Channel | Animations and Cartoons |
| X | Site Channel | Animations and Cartoons/Anime |
| I | City | NY/New York |
| I | Profile Gender | f |
| I | Player Mode | site |

Comparing the advertisement request of Table IV with the advertisement rules of Table V yields the result shown in Table VI:

TABLE VI

| I/X | Key | Key Value | Evaluation |
|---|---|---|---|
| I | Site Channel | Animations and | TRUE |
| | | Cartoons | |
| X | Site Channel | Animations and | FALSE |
| | | Cartoons/Anime | |
| I | City | NY/New York | TRUE |
| I | Profile Gender | f | TRUE |
| I | Player Mode | site | TRUE |

Tolling up the result according to the key group produces the result shown in Table VII:

TABLE VII

| Key | Evaluation |
|---|---|
| Site Channel | FALSE |
| City | FALSE |
| Profile Gender | FALSE |
| Player Mode | TRUE |

Since not all of the key-groups are evaluated to be TRUE, the given ad request is not considered to be a match for the advertisement rule. This example also illustrates the following aspects of advertisement rule evaluation:
(1) The “X:SITE CHANNEL,ANIMATIONS AND CARTOONS/ANIME” advertising rule primitive has higher priority than the “I:SITE CHANNEL,ANIMATIONS AND CARTOONS advertising rule primitive within the “SITE CHANNEL” key group. Or more generally, an exclude advertising rule primitive has effectively higher priority than any include advertising rule primitives within a key-group.
(2) It is difficult to attribute a single reason for the failure of an advertising request to match an advertising rule. In fact, any of the following would apply to the previous example:
   (a) The “SITE CHANNEL,ANIMATIONS AND CARTOONS/ANIME” key-value pair was explicitly excluded
   (b) The advertising request has the wrong value for the City key.
   (c) The advertising request doesn't have a value for the Profile Gender key (specifically the value F)
(3) We can effectively short-circuit the targeting rule evaluation process the moment we discover an unsatisfied key-group.

The targeting rule evaluation process used in the previous examples is rather inefficient. Evaluation of each advertising rule primitive within an advertising rule involves a search for the corresponding key-value pair in the advertisement request, and the entire evaluation process has to be repeated for each live advertisement in the system in order to find the subset of advertisements that qualifies for a given advertisement request. Even opportunities for short-circuiting the evaluation process are taken advantage of, scaling a system to handle thousands of live advertisements and hundreds of advertisement selection requests per second is a significant challenge with the given targeting rule evaluation algorithm.

However, by exploiting the limitations we have imposed on the advertisement rule specification semantics, the following scheme can be used by the advertisement server 322 to evaluate the advertising rules of all advertisements quickly to determine if they qualify for an advertising request. Further, the since set operations (union and intersection) can be performed very quickly with simple AND and OR operations if sets are represented by bit-arrays, the scheme can be efficiently implemented.

Returning to FIG. 4, a first map that relates each advertisement to its advertising rule is precomputed, as shown in block 422. In one embodiment, this is accomplished by loading all advertisements into an array, which serves as a reference point for defining any subsets of advertisements using bit-arrays (or the BitSet class in JAVA). That is, an advertisement at index j of the advertisement array belongs to the subset of advertisements represented by the bit-array S if and only if the j^{th} bit of S is set to one. This can be performed each time ad campaign metadata is refreshed. This can be performed, for example, by the metadata cache service 320 and may be performed, for example, every five minutes.

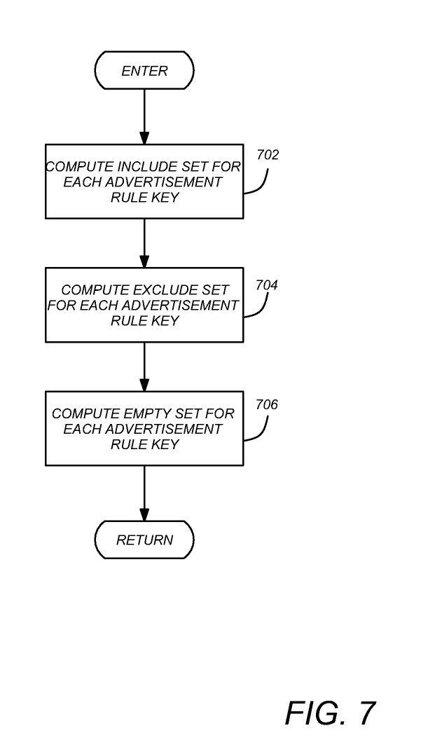

FIG. 7 is a diagram illustrating exemplary method steps that can be used to precompute the first map. As shown in blocks 702-706, an include set, an exclude set, and an empty set are all computed for each advertisement key (or key-value pair) of all live advertisement rule primitives, as shown in blocks 702-706. This may be accomplished, for example, in the metadata cache server 320. The include set, exclude set, and empty set has the following characteristics:

The “include” set—An advertisement belongs to the include set (K,V) iff it has an include advertisement rule primitive (I:K,V) or if it doesn't have any include targeting primitives for the key K.

The “exclude” set—All advertisements belong to the exclude set for (K,V) except for those having an exclude targeting primitive (X:K,V). (e.g. a logical 0 indicates that the advertising rule requires that the primitive be excluded)

“Empty Match” set—For each distinct key K referenced by all live targeting primitives, the metadata cache service 320 computes the bit-array for empty match sets. An “empty” match set is defined such that an ad belongs to the empty match set for a key K iff the advertisement rule does not contain any “include” advertisement rule primitives for that key K.

To illustrate the above process of computing the include set, the exclude set, and the empty set, and in particular by use of a bit array approach, consider the following example in which three advertisements, one for BUD LIGHT, one for RED BULL, and one for BMW, are considered “live” (e.g. suitable for use in responding to advertising requests

The metadata cache service 320 loads the array of advertisements described in Table X:

TABLE VIII
Bud Light
Red Bull
BMW

Further suppose that these advertisements are associated with the following advertising rules, which each have a plurality of advertisement rule primitives.

### BUD LIGHT

TABLE IX

| | | |
|---|---|---|
| I | Content | R |
| | Rating | |
| X | Content | TV-MA |
| | Rating | |

### RED BULL

TABLE X

| | | |
|---|---|---|
| I | Site | Animations and |
| | Channel | Cartoons |
| X | Content | R |
| | Rating | |
| X | Content | TV-MA |
| | Rating | |
| I | Content | TV-14 |
| | Rating | |

### BMW

TABLE XI

| | | |
|---|---|---|
| I | Series | House |
| I | Series | It's Always |
| | | Sunny in |
| | | Philadelphia |
| I | City | CA/Los Angeles |

Based upon these advertisement rules, the metadata cache service 320 computes the include set, the exclude set and the empty set and express those sets in bit arrays.

### Include Set Computation

An advertisement belongs to the include set for a key value pair (K,V) iff (1) the advertisement's advertisement rule has an advertisement rule primitive that has an include designator for that key-value pair (I:K,V) or (2) if the advertisement's advertisement rule has no advertisement rule primitives for the key K.

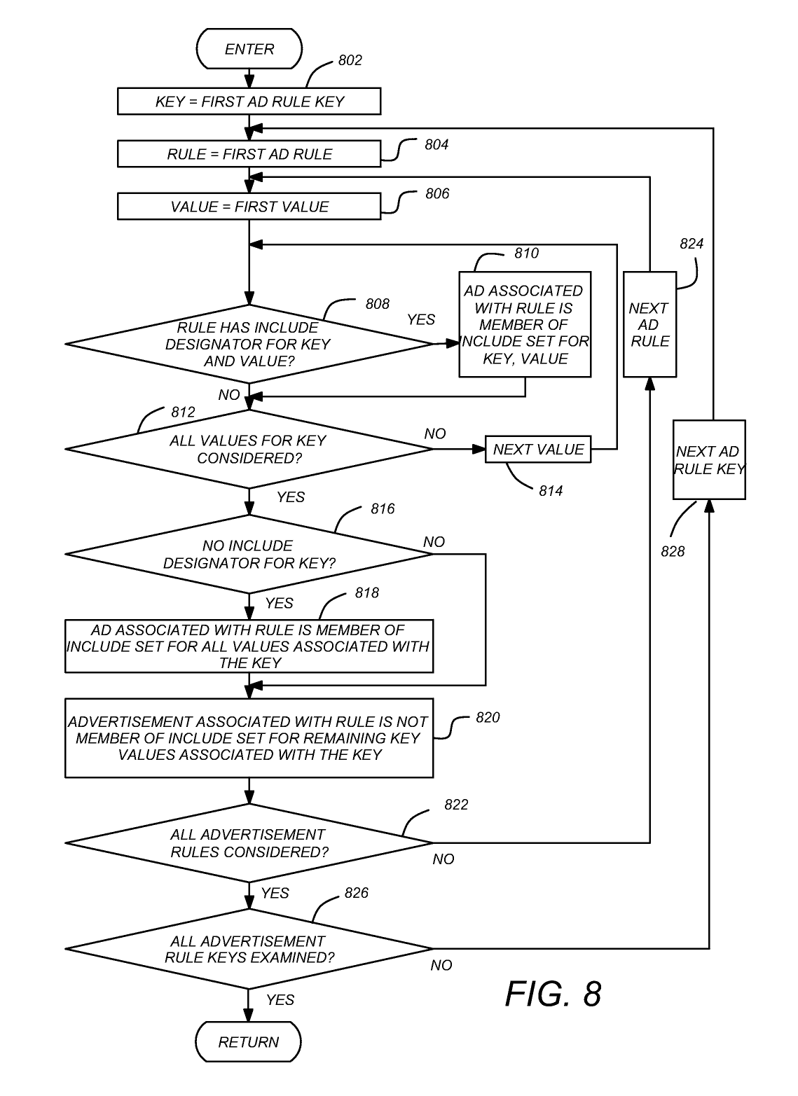

FIG. 8 is a diagram illustrating exemplary method steps that can be used to compute the include set. A first advertisement rule key and advertisement rule and value is considered, as shown in blocks 802, 804, and 806. Block 808 determines whether the advertisement rule has an include designator for the current advertisement rule key-value pair. If so, the advertisement associated with the advertisement rule is designated as a member of the include set for the rule key and value, as shown in block 810, and processing is passed to block 812. If not, processing returns directly to block 812 which determines if all values for the rule key have been considered. If all values for the advertising rule key have not been considered, the next value for the advertising rule key is considered as shown in block 814 and processing returns to block 808.

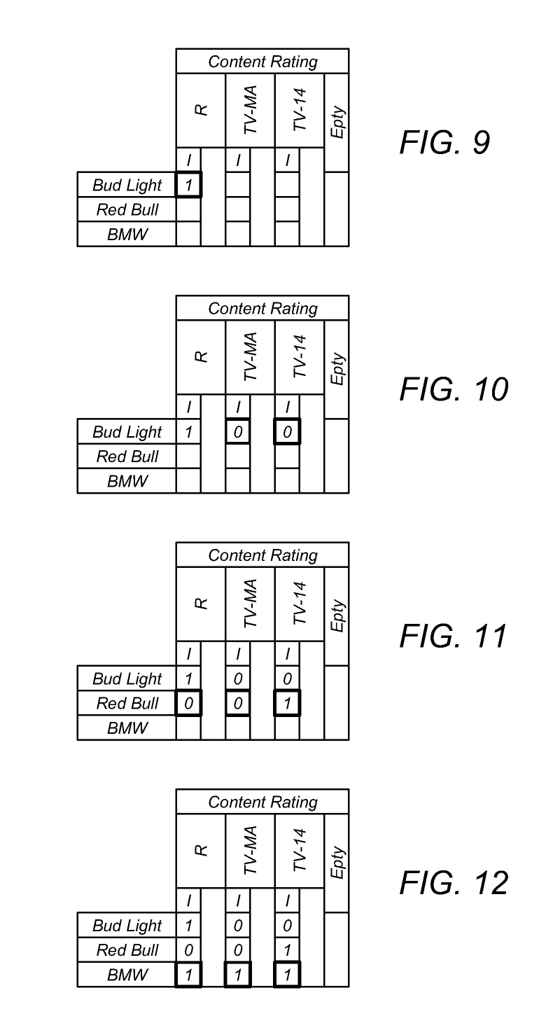

For example, in the above example, consider that block 802 selects the CONTENT RATING key, and block 804 selects the BUD LIGHT advertisement rule, and block 806 selects the “R” value. From above, it is noted that the advertisement rule primitives for the BUD LIGHT advertisement rule indicate that advertisement requests having an “R” value for the rating should be included (I:CONTENT RATING, R). Hence, the advertisement rule BUD LIGHT has an include designator for the “R” value, and the advertisement associated with the BUD LIGHT rule is designated as a member of the include set for the key-value pair (CONTENT RATING, R). This can be indicated by an include set bit array that has a “1” in the position corresponding to the content rating key and the R value, as shown in FIG. 9.

Returning to the example, since all values for the key have not been considered (the BUD LIGHT advertising rule also has a rule primitive that includes the TV-MA value), processing returns to block 808, with and the TV-MA value is evaluated to determine if the advertising rule has an include designator for the key (CONTENT RATING) and the value (TV-14). It does not, because the other BUD LIGHT primitive that has the key-value pair (CONTENT RATING, TV-MA) has an exclude designator instead of an include designator. Since the logic of block 808 tests false, the next key value (TV-14) is considered. It also fails to qualify as a member of the include set, because the BUD LIGHT advertisement rule does not have a TV-14 value for the CONTENT RATING key.

Block 816 determines whether there are no “include” designators for any value of the key. In the current example, BUD LIGHT had an include designator for the “R” value of the CONTENT RATING key, so logic is passed to block 820, which determines that the advertisement associated with the rule is not a member of the include set for the remaining key values associated with the key. In the current example, this means that the advertisement associated with the advertising rule is not a member of the include set for the remaining key-value pairs (CONTENT RATING, TV-MA and CONTENT RATING, TV-14). This can be indicated by an include set bit array that has a “0” in the position corresponding to the content rating key and the TV-MA and TV-14 values, as shown in FIG. 10.

Processing is then passed to block 822, which determines if all advertisement rules have been considered. If not, the next advertisement rule is considered and processing returns to block 806. In the aforementioned example, the RED BULL advertisement rule has not been considered, so blocks 822 and 824 set the rule as RED BULL. Block 806 sets the CONTENT RATING value to R and block 808 determines if the advertising rule has an include designator for the CONTENT RATING,R key-pair. As shown above, the RED BULL advertisement rule has an exclude designator, but not an include designator for the CONTENT RATING,R key-pair, so block 808 passes processing to block 812 so that the processing of blocks 814, 808 and 810 can be repeated for the remaining key-value pairs (CONTENT RATING, TV-MA and CONTENT RATING,TV-14). Since there is an include designator for the CONTENT RATING,TV-14 key-value pair, the advertisement associated with the advertisement rule RED BULL is designated as a member of the include set for the key-value pair CONTENT RATING, TV-14. Thereafter, block 820 designates RED BULL as not a member of the include set for key value pairs CONTENT RATING, R and CONTENT RATING, TV-MA. The result, expressed in a bit array, is shown in FIG. 11.

Returning to FIG. 8, since all advertisement rules have not been considered, processing returns to block 806, with the BMW advertisement rule. The BMW advertisement rule does not have an include designator for the CONTENT RATING, R; CONTENT RATING, TV-14; or the CONTENT RATING, TV-MA key value pairs, so block 816 passes processing to block 818 which indicates that the advertisement associated with the rule is a member of the include set for all of the key-value pairs. The result is a value of “1” for the advertisement rule BMW for all of the key value pairs, as shown in FIG. 12.

Note that this implements a rule whereby if an advertisement rule's advertising primitives specify only one value for a key (e.g. a TV-14 value for the CONTENT RATING key), it is assumed that the other members of the key group (here, the CONTENT RATING key group) are not members of the include set for the advertising rule. This is consistent with the notion that by specifying the I:CONTENT RATING,TV-14 rule primitive, the advertiser does not intend to specify the inclusion of any of the other values for the CONTENT RATING KEY. This is logically implemented by selecting a logical “0” for these bit array elements as shown in FIG. 12. Also note that the foregoing implements a rule whereby if an advertisement rule's primitives specify no value for a particular key, it is assumed that the advertiser does not mind if all of the values for that key are members of the include set for that advertising rule.

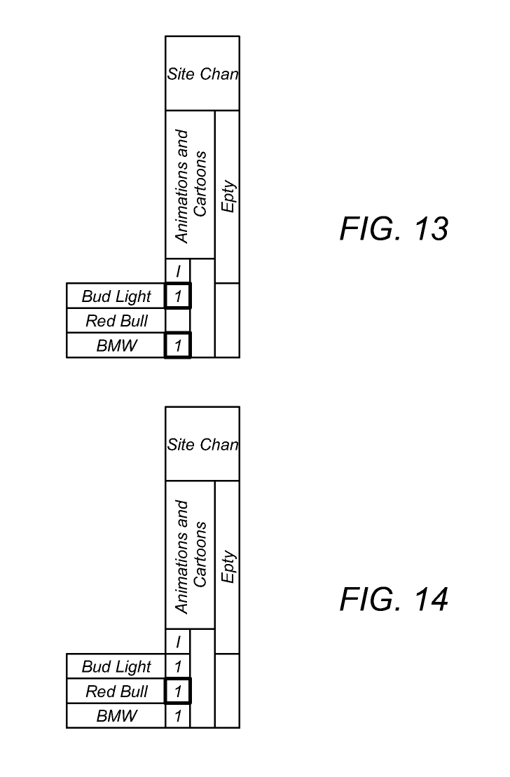

Returning to FIG. 8, block 826 determines if all advertisement rule keys have been examined. Since the SITE CHANNEL, SERIES, and CITY advertisement rule keys have not been examined, block 826 tests false, and processing is returned to block 804 to consider the next rule key, as shown in block 828. Considering the SITE CHANNEL key and the value ANIMATIONS AND CARTOONS, the first advertising rule, BUD LIGHT is examined to determine if the rule has an include designator for the SITE CHANNEL, ANIMATIONS AND CARTOONS key-value pair. As shown above, it does not, and since there is only one value for the SITE CHANNEL key, block 812 evaluates as a yes, passing processing to block 816. Block 816 determines whether there are no include designators for the SITE CHANNEL key. Since the answer is yes, processing is passed to block 818, which makes the advertisement associated with the BUD LIGHT advertisement rule a member of the include set for all values of the SITE CHANNEL key. The same logic provides the same result for the BMW advertisement rule, so the BMW advertisement is a member of the include set for the all values of the SITE CHANNEL key. The result is shown in FIG. 13.

Finally, since the RED BULL advertisement rule includes the SITE CHANNEL, ANIMATIONS AND CARTOONS key value pair, the RED BULL advertisement rule is also in the include set for the SITE CHANNEL, ANIMATIONS AND CARTOONS key value pair. FIG. 14 illustrates an example bit map of this result.

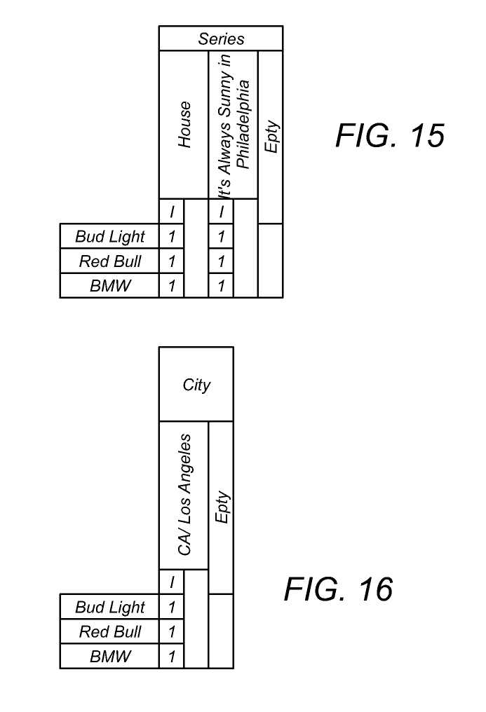

Similar processing rules are applied to the SERIES key and the CITY key, with the results as shown in FIG. 15. Since the BUD LIGHT and RED BULL advertising rules have no values for the SERIES key, the advertisements associated with BUD LIGHT and RED BULL, respectively, is in the include set for all values of the series key (HOUSE and IT'S ALWAYS SUNNY IN PHILADELPHIA). Also, since the BUD LIGHT and RED BULL advertising rules have no values for the CITY key, the advertisements associated with BUD LIGHT and RED BULL are in the include set for all values of the series key (CA/LOS ANGELES). The result is shown in FIG. 16.

Returning to FIG. 7, the next step is to compute an exclude set for each advertisement rule key, as shown in block 704.

### Exclude Set Computation

All advertisements belong to the exclude set for a given key-value pair (K,V) except for those having an exclude targeting primitive (X:K,V).

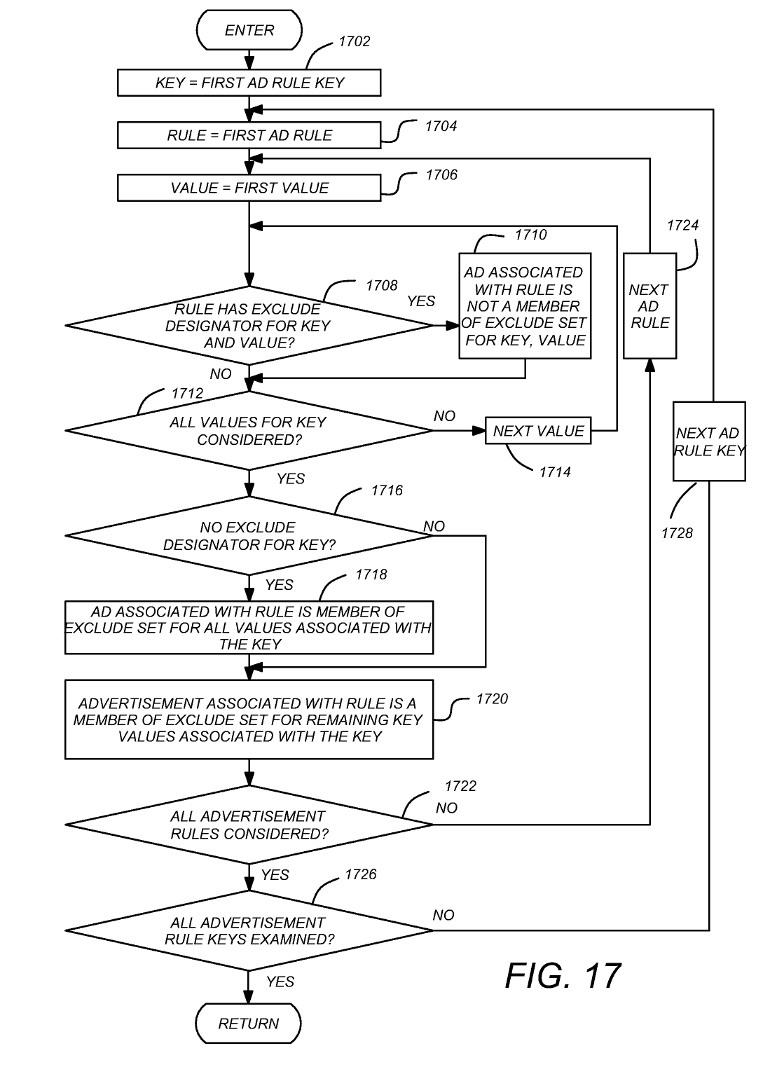

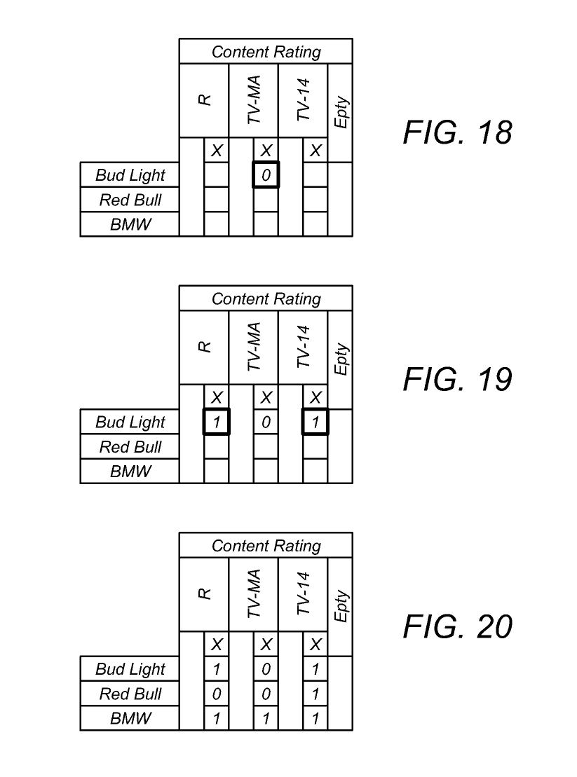

FIG. 17 is a diagram presenting exemplary method steps that can be used to compute the exclude set. As was the case with the include set, the members of the exclude set are determined by considering the advertising rule keys of the advertising primitives. Blocks 1702-1706 set the key, the advertisement rule, and the value under consideration. In the example above, we may begin again the CONTENT RATING key group and the BUD LIGHT advertising rule. For the CONTENT RATING, R key value pair, there is an include designator, but not an exclude designator, so block 1708 tests false, and processing is routed to block 1712. Since not all key values have been considered, the next value is chosen by block 1714, and processing returned to block 1708. For the CONTENT RATING, TV-MA key value pair, the rule primitive that has an exclude delimiter (“X”). This indicates that the BUD LIGHT advertisement is not compatible with a media program with a TV-MA rating and should not be shown. Since all values for the key have not been considered (there remains the TV-14 value), block 1712 returns processing to block 1708 to consider that value. Since there is no CONTENT RATING, TV-14 key value pair for the BUD LIGHT advertisement rule, block 1708 again tests negative, and passes processing to block 1712. Since all values for the CONTENT RATING key have been now examined, processing is passed to block 1716, which determines whether there has been any exclude designator for the key under consideration, which is currently the CONTENT RATING key. Since an exclude designator was found (for the CONTENT RATING, TV-MA key value pair), this block tests false, and processing is passed to block 1720, which determines that the advertisement associated with the rule is a member of the exclude set for the remaining key values associated with the key. The bitmapped result is shown in FIG. 19.

Block 1722 determines if all advertising rules have been considered. Since the RED BULL and BMW advertising rules have not been considered, processing is returned to block 1708 to consider the key-value pairs for those rules. The RED BULL advertising rule has two key value pairs associated with an exclude designator (R, TV-MA), so the advertisement rule is not a member of the exclude set for these two values. Accordingly, a zero is placed in the bitmap for these key value pairs. Further, since the key value pair CONTENT RATING, TV-14 is not associated with an exclude designator, it is a member of the exclude set for this key-value pair. Accordingly, the bitmap includes a zeros for the RED BULL advertising rule for the R and TV-MA values and a one for the TV-14 value.

Finally, the last advertising rule (BMW) is considered. Since the BMW advertising rule has no exclude designators for any key-value pairs associated with CONTENT RATING, processing is passed to block 1716, which determines that there are no exclude designators for the CONTENT RATING key, and block 1718 designates the BMW advertisement as a member of the exclude set for all values associated with the CONTENT RATING KEY. Accordingly, the bit map includes all ones for the BMW advertisement rule. The resulting bitmap is shown in FIG. 20.

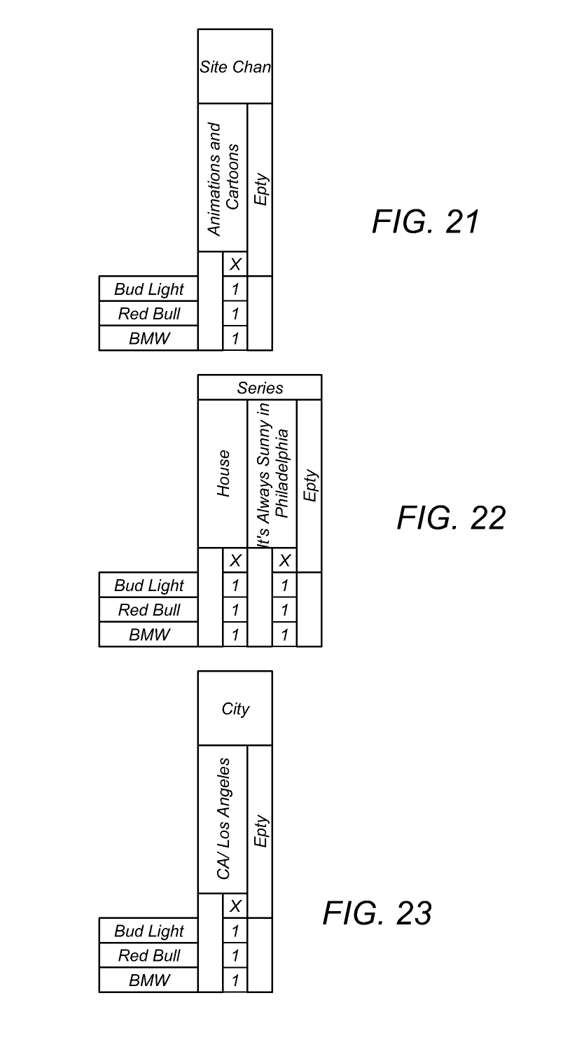

Returning to FIG. 17, block 1726 determines whether all advertising rule keys have been examined. Since the SITE CHANNEL, SERIES, and CITY keys have not been considered, the operations of blocks 1704-1722 are repeated for these advertising rules and key-value pairs, with the results shown in bit array form in FIGS. 21-23.

### Empty Set Computation

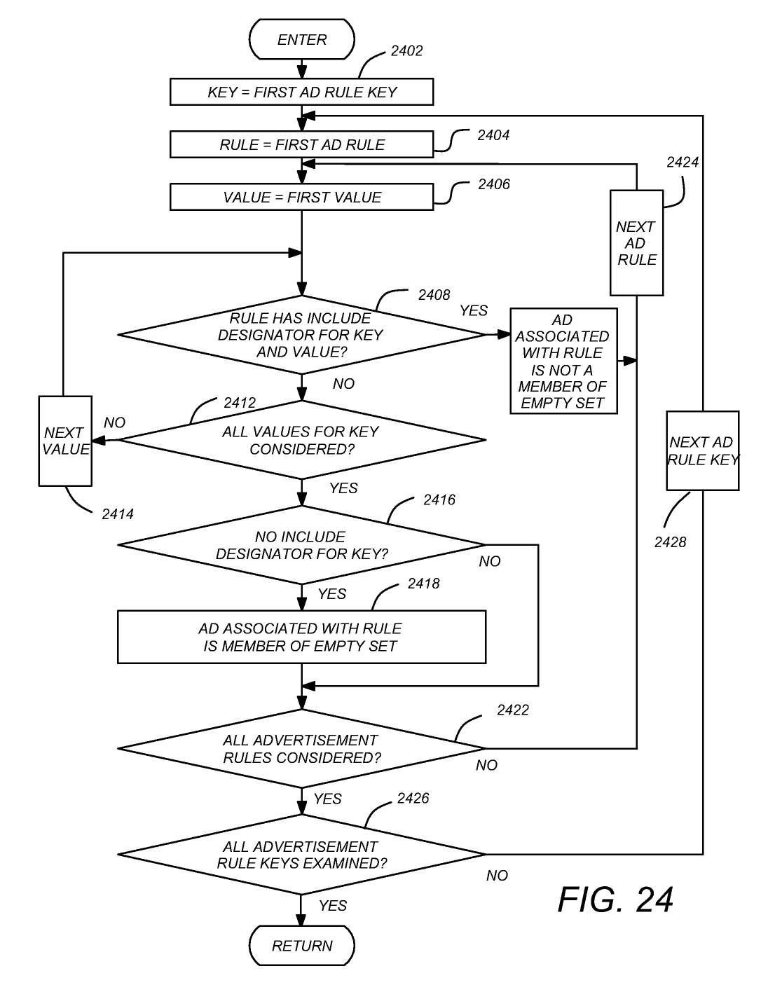

Returning to FIG. 7, an empty set is computed for each advertisement rule key, as shown in block 706. This can be accomplished as shown in FIG. 24.

Blocks 2402-2406 set the rule key, the advertisement rule and the value for consideration. In the foregoing example, we first consider the CONTENT RATING key, the BUD LIGHT advertisement rule, and the R value. Block 2408 determines if the advertisement rule has an include key designator for the CONTENT RATING, R key pair. Since it does, block 2408 routes processing to block 2424 and thereafter to block 2406 to consider the next advertisement rule, RED BULL. Block 2408 then determines that the RED BULL rule does not have an include designator for the CONTENT RATING, R key value pair, and routes processing to block 2412. Block 2412 determines that not all values for the key have been considered, so processing is routed to block 2414 which sets the value to the next value (TV-MA) and routes processing back to block 2408. Since the CONTENT RATING, TV-MA key value pair does not have an include designator, block 2408 again tests as false, and blocks 2412 and 2414 route processing to consider the key value pair CONTENT RATING, TV-14. Block 2408 determines that the RED BULL advertisement rule has an include designator for the CONTENT RATING, TV-14 key value pair, so processing is routed to block 2424 to consider the next advertisement rule, BMW.

Block 2408 determines that the BMW advertisement rule does not have an include designator for the CONTENT RATING, R key value pair Likewise, blocks 2412, 2414 and 2408 consider whether the BMW advertisement rule has an include designator for the CONTENT RATING TV-MA key value pair or the CONTENT RATING, TV-14 key value pair. Since the answer is no in both cases, block 2416 determines that there were no include designators for the CONTENT RATING key for the BMW advertisement rule, and so passes processing to block 2418, which designates that the BMW ad associated with the BMW rule is a member of the empty set for all values associated with the CONTENT RATING KEY (including the R, TV-MA and TV-14 values). Accordingly, a “1” is placed in the bit array for the element relating BMW and the empty set for the CONTENT RATING key. The resulting bitmap is shown in FIG. 26.

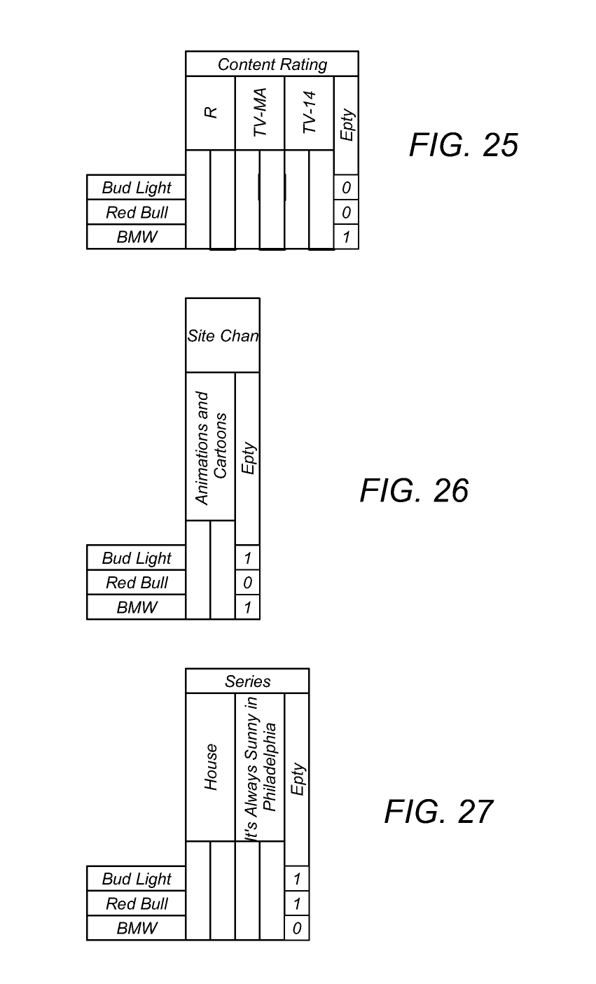

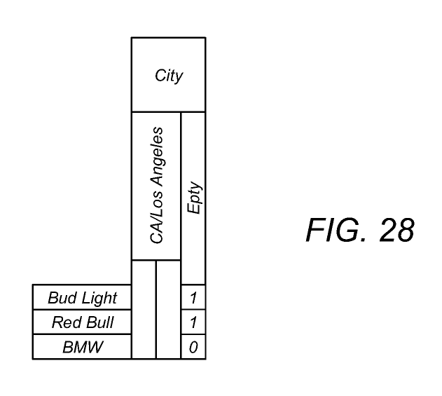

Block 2426 determines that all keys have not been examined, and passes processing to block 2428, which selects the next key for consideration (SITE CHANNEL, SERIES, or CITY) and routes processing to block 2404 so the key values for the advertising rules can be considered. FIGS. 24-28 show the resulting empty set bitmaps.

Note that the effect of the operations shown in FIG. 24 is that an advertising rule will be deemed to be a member of the empty set for a particular key if the advertising rule has no advertising primitive with an include designator. Otherwise (if at least one of the primitives for the advertising rule key has an include designator), the advertising rule is deemed not to be a member of the empty set. The effect of the empty set computation is if the advertising rule specifies a value for a particular rule, it is assumed that any other possible values for the rule key are not desired to be included by the advertisement rule. In other words, if an advertisement rule specifies CA/LOS ANGELES value for the city key, it is assumed that other possible values for the same key (e.g. other cities) are not in the advertising rule. Hence, if an advertising request includes NY/NEW YORK value for the city advertising request key, an advertisement rule that includes CA/LOS ANGELES, but is silent with respect to NY/NEW YORK mandates that the related advertisement does not satisfy the advertising request. However, if the advertisement rule does not include any value for the CITY key, it is assumed that the advertising rule permits any value for the CITY key.

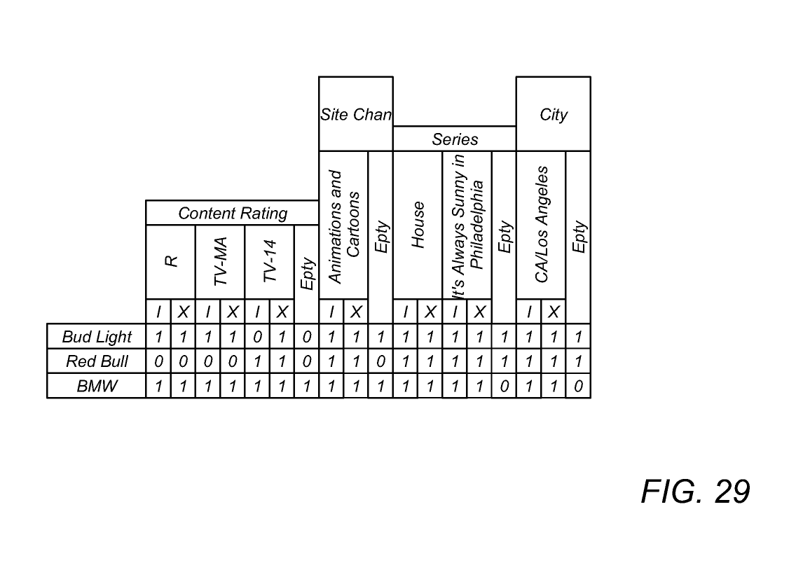

The foregoing results comprise the aforementioned first map relating each advertisement to its advertisement rule values. The results may be aggregated into a single bitmap as shown in FIG. 29 by joining appropriate columns.

Returning to FIG. 4, the media program player 304 determines that an advertisement opportunity exists. This advertisement opportunity may be temporally before the playing of the media program, during the playback of the media program (during an advertisement interruption) or after the playing of the media program. In response to this determination, an advertisement selection request is transmitted to the ad server 322, as shown in block 424. That selection request may include demographic information about the user, the media program being viewed, the user's computer, or any other information that might be useful in selecting an advertisement for playback. To minimize the bandwidth required to transmit such information, the advertisement request may instead include information identifying the user and the media program, and the ad server 322 may use this identifying information to retrieve more detailed information from internal or external databases. For example, consider the following ad selection request for the first ad position of an episode of HOUSE:

<AdRequest Pod=“0” SessionState=“” ResponseType=“SMIL”><Distributor
Platform=“Hulu”Name=“Hulu”/>
<VisitorComputerGuid=“EC173206B9124954F33D23BA78BA0C22”
State=“[fch,]”BT_RSSegments=“K08783_10001,K08783_10002,K08783_10003”/>
<KeyValues><KeyValue Key=“env” Value=“prod” />
<KeyValue Key=“version”Value=“2” />
</KeyValues><SiteLocation><VideoPlayer Mode=“site”
Url=“http://www.hulu.com/player.swf?v=BtOelDuU774ZSSQKRxuxwSspHo8”><Video
Asset BitRate=“700” Height=“360” Width=“480” Id=“50016653”
PId=“bd9MvLzKu1nA_ekQpqOKQpiZ9mdAxDrO”/>
</VideoPlayer></SiteLocation><Diagnostics />
</AdRequest>

Upon receiving the advertisement request above, the ad selection service 316 may use the information in the advertisement request such as the video ID, user ID, computer guID embedded in the request and/or the IP address of the user as information keys into the metadata caches service 320 to generate a list of key-value pairs (key=value) for the advertisement request such as:
PId=bd9MvLzKu1nA_ekQpqOKQpiZ9mdAxDrO

### Content Rating=TV-14

### Genre=Drama

Site Channel=drama
Site Channel=drama/medical

### ChanType=Primary

### PlatformId=50016653

### Content Partner=fbc

### Content Partner Group=Fox Buyback

Series=house

### Video Group=Onstar Full List

### Video Group=Best In Show Bracket

### Video Group=ING DIRECT

### Video Group=American Airline Final List2

showdemo=FA18to49
showdemo=A18to49
Has Computer Guid=true

### Distribution Partner=Hulu

### Distribution Platform=Hulu

### Video Ad Model=FullEpisode

### Pod=0

Player Mode=site

### Operating System=Windows

### Operating System=Vista

### Zip Code=90064

### State=CA

### City=CA/Los Angeles

### Country=US

### DMA=Los Angeles

### Domain=

top_level_domain=

### ISP=Hulu, LLC

age=35-49
education=High school
employ=Full-time student
gender=m
household=no children
income=50 k-75 k
marital=Single, not living with domestic partner
env=prod
version=2

Noteworthy is the fact that the list of key-values above includes not just metadata about the related media program but also geographic and demographic information about the user. This provides a high degree of flexibility regarding how advertisers may can target their advertisements. Furthermore, since all information about an advertisement request is essentially a list of advertisement key-value pairs, and they can be compared to complementary logical advertisement rule “primitives” that evaluate to True or False.

Returning to block 426 of FIG. 4, the advertising request is received. That advertising request has one or more advertising request keys, each of which has one or more advertising request values.

### Computing the Subset of Advertisements that Qualify for an Advertisement Request

To compute the subset of advertisements that qualify for a given advertisement request, the ad select service 316 retrieves at least a portion of the precomputed first map, and computes a second map from the portion of the precomputed first map, as shown in blocks 428 and 430. The portion of the precomputed first map that is retrieved are those portions which have ad rule key-values that match the key-value pairs in the advertising request. This is can be accomplished, for example, by using the key-value pairs of the advertisement request as index into the set of bit-arrays precomputed by the metadata cache service 320. Returning to the example described above, if the advertising request of Table XVIII is received:

TABLE XII

| Key | Value |
|---|---|
| CONTENT | TV-MA, TV-14 |
| RATING | |
| SITE CHANNEL | COMEDY |
| SERIES | IT'S ALWAYS SUNNY IN |
| | PHILADELPHIA |
| CITY | CA/LOS ANGELES |

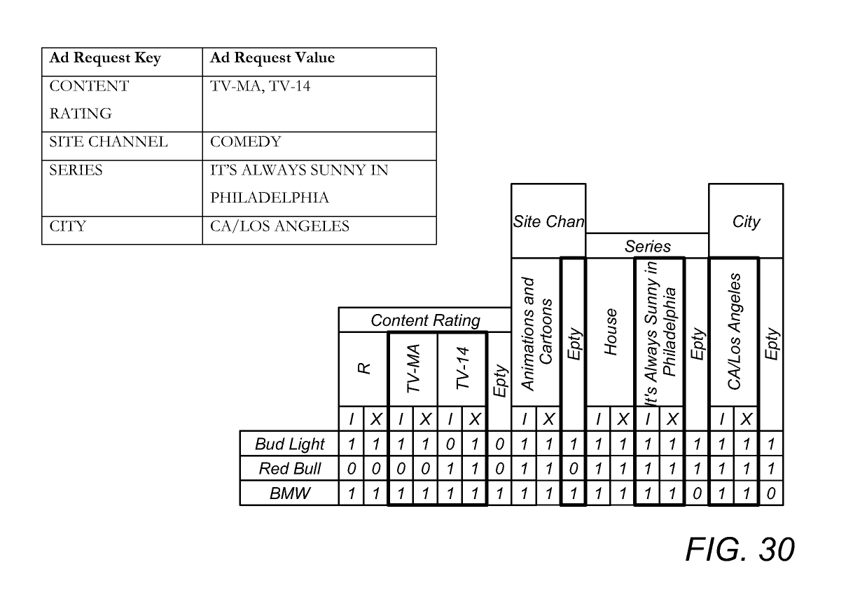

In the example shown above, the advertisement select service 316 retrieves the portion of the bit map shown in FIG. 30. In the above example, those are the portions of the map having the key-value pairs CONTENT RATING, TV-MA; CONTENT RATING TV-14; SITE CHANNEL, COMEDY; SERIES, IT'S ALWAYS SUNNY IN PHILADELPHIA; and CITY, LOS ANGELES. These portions of the precomputed bit array are shown in FIG. 30. Returning to FIG. 4, a second map is computed from the portion of the precomputed first map, as shown in block 430. The second map is computed by combining the retrieved precomputed maps or bit arrays in a manner analogous to how targeting primitives in a single targeting rule are joined by logical AND and OR operators.

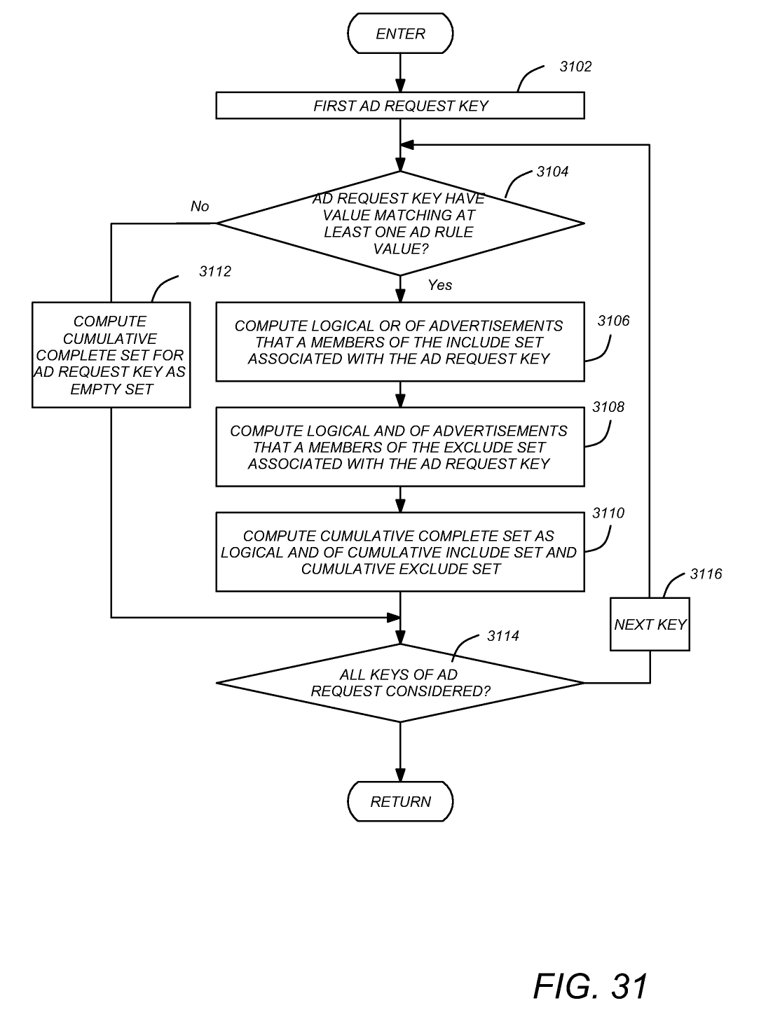

FIG. 31 is a diagram showing method steps that can be used to compute the second map. A cumulative include set and the bit array representing the set can be computed computing a logical OR of all include bit-arrays elements referenced by all advertisement request key-values K,V₁ . . . K,Vₙ that are included the advertisement request. A cumulative exclude set and the bit array representing that set can be computed by ANDing all the exclude bit arrays referenced by the advertisement request key-values. The cumulative include bit array and the exclude bit array are ANDed for each key group. For advertising request key values that do not match any advertisement rule value, the empty set is selected for the cumulative complete set with respect to that advertising request key value.

First, an a key of the received advertising request is selected for consideration, as shown in block 3102. Block 3104 determines whether that advertising request key has a value matching at least one of the advertising rule values. In the example above, suppose the CONTENT RATING ad request key the key selected in block 3102. Block 3104 would determine that the CONTENT RATING ad request key has at least one matching advertising rule value among the advertisements, so block 3104 would pass processing to block 3106. Block 3106 computes a logical OR of the advertisements that are members of the include set associated with the CONTENT RATING advertisement request key. The set members include advertisements having a TV-MA and TV-14 advertisement rule, as shown below in Table XIII.

TABLE XIII

| TV-MA | TV-14 | Cumulative Include |
|---|---|---|
| I | I | Bit Array |
| 1 | 0 | (1\|0) = 1 |
| 0 | 1 | (0\|1) = 1 |
| 1 | 1 | (1\|1) = 1 |

Block 3108 computes the logical AND of advertisements that are a member of the exclude set associated with the ad request key (CONTENT RATING). The result is as shown in Table XIV below:

TABLE XIV

| TV-MA | TV-14 | Cumulative Exclude |
|---|---|---|
| X | X | Bit Array |
| 1 | 1 | (1&1) = 1 |
| 0 | 1 | (0&0) = 0 |
| 1 | 1 | (1&1) = 1 |

Block 3110 computes a cumulative complete set as a logical AND of the cumulative include set and the cumulative exclude set. The result is shown below in Table XV:

TABLE XV

| Cumulative | Cumulative | Cumulative Set |
|---|---|---|
| Include Bit | Exclude Bit | for Content |
| Array | Array | Rating Key Group |
| 1 | 1 | (1&1) = 1 |
| 0 | 0 | (0&0) = 0 |
| 1 | 1 | (1&1) = 1 |

The computation of the cumulative complete set for the “content rating” key group can be summarized as shown in Table XVI below:

TABLE XVI

| | | | | Cumulative Set for |
|---|---|---|---|---|
| TV-MA | | TV--14 | | Content Rating Key |
| I | X | I | X | Group |
| 1 | 1 | 0 | 1 | (1\|0)&(1&1) = 1 |
| 0 | 0 | 1 | 1 | (0\|1)&(0&1) = 0 |
| 1 | 1 | 1 | 1 | (1\|1)&(1&1) = 1 |

The advertisement request also included the SITE CHANNEL, SERIES, and CITY keys, so all keys have not been considered, and block 3114 tests negative and passes logic to block 3116. Block 3116 selects the next key (e.g. SITE CHANNEL) and passes processing to block 3104 which again determines if the ad request key SITE CHANNEL has a value matching at least one advertisement rule value. Since the SITE CHANNEL request key has the value COMEDY and none of the values associated with the advertisement rule SITE CHANNEL are COMEDY, block 3104 tests false, and processing is passed to block 2812, which sets the cumulative complete set for the current ad request key (SITE CHANNEL) as the empty set. The result is shown in Table XVII.

TABLE XVII
Site Channel

| Empty | Result |
|---|---|
| 1 | 1 |
| 0 | 0 |
| 1 | 1 |

Using similar operations, the cumulative bit array for the “series” key group and the “city” key group are defined as shown in Tables XXIV and XXV respectively:

TABLE XXIV

| It's Always Sunny in | | Cumulative Set |
|---|---|---|
| Philadelphia | | for Series |
| I | X | Key Group |
| 1 | 1 | (1)&(1) = 1 |
| 1 | 1 | (1)&(1) = 1 |
| 1 | 1 | (1)&(1) = 1 |

TABLE XXV

| CA/Los Angeles | | Cumulative Set for |
|---|---|---|
| I | X | City Key Group |
| 1 | 1 | (1)&(1) = 1 |
| 1 | 1 | (1)&(1) = 1 |
| 1 | 1 | (1)&(1) = 1 |

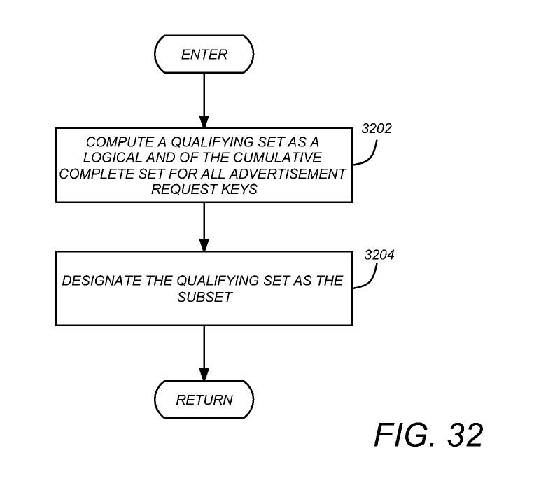

FIG. 32 is a diagram illustrating exemplary method steps that can be used to select the subset of advertisements from the second map. A qualifying set is computed as a logical AND of the cumulative complete set for all of the advertisement request keys, as shown in block 3202. In the example above, the final qualifying set is created by ANDing the elements of each row all of the cumulative bit arrays for each advertisement request key. This qualifying set is then designated as the subset of advertisements having advertisement rules satisfying the advertisement request, as shown in block 3204. The result is shown in Table XXVI below:

TABLE XXVI

| Cumulative Set | Cumulative | Cumulative | Cumulative | |
|---|---|---|---|---|
| for Content | Set for Site | Set for | Set for | |
| Rating Key | Channel | Series Key | City Key | |
| Group | Key Group | Group | Group | Result |
| 1 | 1 | 1 | 1 | 1&1&1&1 = 1 |
| 0 | 0 | 1 | 1 | 0&0&1&1 = 0 |
| 1 | 1 | 1 | 1 | 1&1&1&1 = 1 |

This indicates that both the Bud Light and BMW advertisement rules are satisfied by the advertising request (that the Bud Light and BMW advertisement rules permit those advertisements to be provided in response to the advertising request.

The above process can be summarized as follows. For each live distinct key K in the advertisement request, the ad select service 316:
(1) Computes a cumulative include set by ORing all include bit-arrays referenced by all key-values K,V₁ . . . K,Vₙ on the advertisement request. This produces the set of advertisements that have advertising rules that have an include primitive for one of the values for K on the advertisement request or ads that don't have any include rules for K.
(2) Computes a cumulative exclude set by ANDing all exclude bit-arrays referenced by all key-values K,V₁ . . . K,Vₙ on the advertisement request. This produces the set of advertisements that don't have any exclude primitives referencing K,V₁ . . . K,Vₙ on the advertisement request.
(3) Computes a cumulative set for the key K by ANDing the cumulative include bit-array with the cumulative exclude bit-array. If a given request doesn't contain any values for K, the cumulative set is taken to be the empty match set for K. The cumulative set for K is effectively the subset of ads that satisfies the key group K.
(4) To arrive at the final subset of qualifying ads, the ad selection service 316 ANDs the cumulative bit-arrays for all distinct live keys. Any key-value pairs on the advertisement request that doesn't match a bit-array computed by metadata cache service will have no bearing on the final result since there are not any advertisements targeting against them.

Compared with the more intuitive targeting rule evaluation process used in the earlier examples, the bit-array-based approach has the following advantages:
(A) Look-up of bit-arrays is driven from key-values on the request which is typically on a much smaller scale than driving look-up of key-values from targeting primitives of all live ads. The use of bit-wise operators effectively combines targeting primitives from multiple ads in parallel. On modern computers, this typically means combining 64 targeting primitives in a single clock-cycle (provided that the operands are readily available)
(B) Bit-arrays are more efficient memory-wise (and processor cache-friendly) for representing targeting primitives compared with representing them explicitly. This is true even if we account for the fact that certain bits are wasted for ads that don't have particular targeting primitive for a specific key-value pair.

Finally, returning to FIG. 4, the subset of advertisements are used to generate a play list, as shown in block 434. In one embodiment, the playlist includes a list of all of the advertisements in the subset of advertisements (and sufficient information to retrieve them for playback at the appropriate time). In other embodiments, the playlist comprises fewer advertisements than are included in the subset, with the playlist determined according to other factors such as (1) whether the advertisement has already been shown to the viewer (2) potential negative feedback regarding the advertisement from the viewer (3) whether the advertisement is appropriately grouped with other advertisements in the subset and (4) which order the advertisements in the playlist should be shown. Finally, the playlist is transmitted to the media program player 304 where it is received and used to select advertisements or playback.

Returning to FIG. 3, the playback list (or advertising list) is transmitted from the advertisement server 322 to the media program player.

The decision regarding which of the advertisements to play and in which order can be determined in the media program player 304 itself, or can be determined by the ad select service 316. Further, the ad select service 316 may generate a preliminary playlist, and allow the media program player 304 to make the final determination of which advertisements to play and when. If desired, these final play decisions may be based on information that is kept private in the user's computer hosting the media program player 304.

### CONCLUSION

This concludes the description of the preferred embodiments of the present invention. In summary, the present invention describes a method and apparatus for selecting a subset of advertisements complying with an advertisement request from a set of advertisements.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

1. A method of selecting a subset of advertisements complying with an advertisement request from a set of advertisements, comprising the steps of:
accepting an advertisement rule for each advertisement of the set of advertisements, each advertisement rule describing circumstances in which the associated advertisement belong to the subset of advertisements, each advertisement rule comprising:
one or more advertisement rule primitives, each advertisement rule primitive comprising a advertisement rule key and a advertisement rule value associated with the advertisement rule key;
precomputing a first map relating each advertisement to its advertisement rule values;
accepting an advertisement request having one or more advertisement request keys, each of the advertisement request keys having one or more advertisement request values;
retrieving, in response to the advertisement request, at least a portion of the precomputed map, the at least a portion describing the advertisement rules for which advertisement rule values match the advertisement request values;
computing a second map from the portion of the precomputed first map; and
selecting the subset of advertisements from the second map as only those advertisements having advertisement rules satisfied by all of the advertisement request values.

2. The method of claim 1, wherein:
the advertisement rule is defined according to a semantic logically ORing each value of each key and logically ANDing each of the keys, and excluding a logical AND of the key values and a logical OR of the keys.

3. The method of claim 2, wherein each advertisement rule primitive further comprises either an include designator indicating that the advertisement rule includes the associated advertisement rule value or an exclude designator indicating that the advertisement rule excludes the associated advertisement rule value, and wherein the step of precomputing the first map relating each advertisement to its advertisement rule values comprises the steps of:
for each advertisement rule key, computing an include set, wherein an advertisement belongs in the include set if and only if the associated advertisement rule includes a rule primitive having an include designator or if the associated advertisement rule does not include any advertisement rule primitives having the advertisement rule key;
for each advertisement rule key, computing an exclude set, wherein an advertisement belongs in the exclude set unless the associated advertisement rule includes a rule primitive having an exclude designator; and
for each advertisement rule key, computing an empty match set, wherein an advertisement belongs in the empty match set for the advertisement rule key if the advertisement primitive does not include any include designators associated with the advertisement rule key.

4. The method of claim 3, wherein:
the step of computing a second map from the portion of the precomputed map comprises the steps of:
for each advertisement request key of the advertisement request having an advertisement request value matching at least one of the advertisement rule values,
computing a cumulative include set for the advertisement request key as a logical OR of all advertisements that are members of the include set associated with the advertisement request key;
computing a cumulative exclude set for the advertisement request key as a logical AND of all advertisements that are members of the exclude set associated with the advertisement request key;
computing a cumulative complete set for the advertisement request key as a logical AND of the cumulative include set and the cumulative exclude set associated with the advertisement request key
for each advertisement request key of the advertisement request having no advertisement request value matching any of the advertisement rule values;
computing the cumulative complete set for the advertisement key as the empty set associated with the advertisement request key;
wherein the step of selecting the subset of advertisements from the second map comprises the step of:
computing a qualifying set as a logical AND of the cumulative complete set for all advertisement request keys;
designating the qualifying set as the subset.

5. The method of claim 4, wherein:
the include set for each advertisement request key is expressed as an include set bit array for each advertisement request key;
the exclude set for each advertisement request key is expressed as an exclude set bit array for each advertisement request key;
the empty match set for each advertisement request key is expressed as an empty match set bit array for each advertisement request key;
the cumulative include set for each advertisement request key is cumulative set bit array for each advertisement request key;
the cumulative exclude set for each advertisement request key is a cumulative exclude set bit array for each advertisement request key; and
the cumulative complete set for each advertisement request key is a cumulative complete set bit array for each advertisement request key.

6. The method of claim 5, wherein:
the include set bit array includes a logical 1 for rule primitives having the include designator;
the exclude set bit array includes a logical 0 for rule primitives having the exclude designator
the subset of the advertisements are includes only those advertisements having an associated bit array element of a logical 1.

7. An advertisement server for selecting a subset of advertisements complying with an advertisement request from a set of advertisements, comprising:
a metadata cache service, the metadata cache service for accepting an advertisement rule for each advertisement of the set of advertisements, each advertisement rule describing circumstances in which the associated advertisement belong to the subset of advertisements, each advertisement rule comprising one or more advertisement rule primitives, each advertisement rule primitive comprising a advertisement rule key and a advertisement rule value associated with the advertisement rule key, and for precomputing a first map relating each advertisement to its advertisement rule values; and
an advertisement selection service communicatively coupled to the metadata cache service, for accepting an advertisement request having one or more advertisement request keys, each of the advertisement request keys having one or more advertisement request values, for retrieving, in response to the advertisement request, at least a portion of the precomputed map, the at least a portion describing the advertisement rules for which advertisement rule values match the advertisement request values, for computing a second map from the portion of the precomputed first map, and for selecting the subset of advertisements from the second map as only those advertisements having advertisement rules satisfied by all of the advertisement request values.

8. The apparatus of claim 7, wherein:
the advertisement rule is defined according to a semantic logically ORing each value of each key and logically ANDing each of the keys, and excluding a logical AND of the key values and a logical OR of the keys.

9. The apparatus of claim 8, wherein each advertisement rule primitive further comprises either an include designator indicating that the advertisement rule includes the associated advertisement rule value or an exclude designator indicating that the advertisement rule excludes the associated advertisement rule value, and wherein advertisement selection service comprises:
a first module for computing an include set for each advertisement rule key, wherein an advertisement belongs in the include set if and only if the associated advertisement rule includes a rule primitive having an include designator or if the associated advertisement rule does not include any advertisement rule primitives having the advertisement rule key;
a second module for computing an exclude set for each advertisement rule key, wherein an advertisement belongs in the exclude set unless the associated advertisement rule includes a rule primitive having an exclude designator;
a third module for computing an empty match set for each advertisement rule key, wherein an advertisement belongs in the empty match set for the advertisement rule key if the advertisement primitive does not include any include designators associated with the advertisement rule key.

10. The apparatus of claim 9, wherein the advertisement selection service further comprises:
a fourth module for computing the second map from the portion of the precomputed map, the fourth module for computing, for each advertisement request key of the advertisement request having an advertisement request value matching at least one of the advertisement rule values, a cumulative include set for the advertisement request key as a logical OR of all advertisements that are members of the include set associated with the advertisement request key; computing a cumulative exclude set for the advertisement request key as a logical AND of all advertisements that are members of the exclude set associated with the advertisement request key; and computing a cumulative complete set for the advertisement request key as a logical AND of the cumulative include set and the cumulative exclude set associated with the advertisement request key, and
a fifth module for computing the cumulative complete set for the advertisement key as the empty set associated with the advertisement request key for each advertisement request key of the advertisement request having no advertisement request value matching any of the advertisement rule values.

11. The apparatus of claim 10, wherein the advertisement selection service further comprises:
a sixth module for selecting the subset of advertisements from the second map by computing a qualifying set as a logical AND of the cumulative complete set for all advertisement request keys and designating the qualifying set as the subset.

12. The apparatus of claim 11, wherein:
the include set for each advertisement request key is expressed as an include set bit array for each advertisement request key;
the exclude set for each advertisement request key is expressed as an exclude set bit array for each advertisement request key;
the empty match set for each advertisement request key is expressed as an empty match set bit array for each advertisement request key;
the cumulative include set for each advertisement request key is cumulative set bit array for each advertisement request key;
the cumulative exclude set for each advertisement request key is a cumulative exclude set bit array for each advertisement request key; and
the cumulative complete set for each advertisement request key is a cumulative complete set bit array for each advertisement request key.

13. The apparatus of claim 12, wherein:
the include set bit array includes a logical 1 for rule primitives having the include designator;
the exclude set bit array includes a logical 0 for rule primitives having the exclude designator
the subset of the advertisements are includes only those advertisements having an associated bit array element of a logical 1.

14. An apparatus of selecting a subset of advertisements complying with an advertisement request from a set of advertisements, comprising:
means for accepting an advertisement rule for each advertisement of the set of advertisements, each advertisement rule describing circumstances in which the associated advertisement belong to the subset of advertisements, each advertisement rule comprising:
one or more advertisement rule primitives, each advertisement rule primitive comprising a advertisement rule key and a advertisement rule value associated with the advertisement rule key;
means for precomputing a first map relating each advertisement to its advertisement rule values;
means for accepting an advertisement request having one or more advertisement request keys, each of the advertisement request keys having one or more advertisement request values;
means for retrieving, in response to the advertisement request, at least a portion of the precomputed map, the at least a portion describing the advertisement rules for which advertisement rule values match the advertisement request values;
means for computing a second map from the portion of the precomputed first map; and
means for selecting the subset of advertisements from the second map as only those advertisements having advertisement rules satisfied by all of the advertisement request values.

15. The apparatus of claim 14, wherein:
the advertisement rule is defined according to a semantic logically ORing each value of each key and logically ANDing each of the keys, and excluding a logical AND of the key values and a logical OR of the keys.

16. The apparatus of claim 14, wherein each advertisement rule primitive further comprises either an include designator indicating that the advertisement rule includes the associated advertisement rule value or an exclude designator indicating that the advertisement rule excludes the associated advertisement rule value, and wherein the means for precomputing the first map relating each advertisement to its advertisement rule values comprises:
means for computing an include set for each advertisement rule key, wherein an advertisement belongs in the include set if and only if the associated advertisement rule includes a rule primitive having an include designator or if the associated advertisement rule does not include any advertisement rule primitives having the advertisement rule key;
means for computing an exclude set for each advertisement rule key, wherein an advertisement belongs in the exclude set unless the associated advertisement rule includes a rule primitive having an exclude designator;
means for computing an empty match set for each advertisement rule key, wherein an advertisement belongs in the empty match set for the advertisement rule key if the advertisement primitive does not include any include designators associated with the advertisement rule key.

17. The apparatus of claim 16, wherein:
the means for computing a second map from the portion of the precomputed map comprises:
means for computing a cumulative include set for the advertisement request key as a logical OR of all advertisements that are members of the include set associated with the advertisement request key, for computing a cumulative exclude set for the advertisement request key as a logical AND of all advertisements that are members of the exclude set associated with the advertisement request key, and for computing a cumulative complete set for the advertisement request key as a logical AND of the cumulative include set and the cumulative exclude set associated with the advertisement request key for each advertisement request key of the advertisement request having an advertisement request value matching at least one of the advertisement rule values;
means for computing the cumulative complete set for the advertisement key as the empty set associated with the advertisement request key for each advertisement request key of the advertisement request having no advertisement request value matching any of the advertisement rule values;
wherein the means for selecting the subset of advertisements from the second map comprises:
means for computing a qualifying set as a logical AND of the cumulative complete set for all advertisement request keys;
means for designating the qualifying set as the subset.

18. The apparatus of claim 17, wherein:
the include set for each advertisement request key is expressed as an include set bit array for each advertisement request key;
the exclude set for each advertisement request key is expressed as an exclude set bit array for each advertisement request key;
the empty match set for each advertisement request key is expressed as an empty match set bit array for each advertisement request key;
the cumulative include set for each advertisement request key is cumulative set bit array for each advertisement request key;
the cumulative exclude set for each advertisement request key is a cumulative exclude set bit array for each advertisement request key; and
the cumulative complete set for each advertisement request key is a cumulative complete set bit array for each advertisement request key.

19. The apparatus of claim 18, wherein:
the include set bit array includes a logical 1 for rule primitives having the include designator;
the exclude set bit array includes a logical 0 for rule primitives having the exclude designator
the subset of the advertisements are includes only those advertisements having an associated bit array element of a logical 1.
